(19) United States
(12) Patent Application Publication
(10) Pub. No.: US 2022/0413268 A1
(43) Pub. Date: Dec. 29, 2022

(54) ZOOM LENS AND IMAGE PICKUP APPARATUS INCLUDING ZOOM LENS

(71) Applicant: OM DIGITAL SOLUTIONS CORPORATION, Tokyo (JP)

(72) Inventors: Toyoki KON, Tokyo (JP); Yasuharu YAMADA, Tokyo (JP)

(73) Assignee: OM DIGITAL SOLUTIONS CORPORATION, Tokyo (JP)

(21) Appl. No.: 17/709,750

(22) Filed: Mar. 31, 2022

(30) Foreign Application Priority Data
Jun. 29, 2021 (JP) 2021-107570

(51) Int. Cl. G02B 15/14; H04N 5/232

(52) U.S. Cl. CPC G02B 15/1451; H04N 5/23296; G02B 15/1461

(57) ABSTRACT

A zoom lens includes, in order from an object side, a first lens group G1 having a positive focal length, a second lens group G2 having a negative focal length, a third lens group G3 including an aperture stop S and having a positive focal length, a fourth lens group G4 having a negative focal length, and a rear side lens group G5. The first lens group includes a negative lens and a positive lens disposed in order from a most object side. The first lens group and the third lens group are fixed in power varying from a wide angle end to a telephoto end. The second lens group moves from the object side to an image side in the power varying. The zoom lens satisfies following conditional expressions (1) and (2).

2.1≤F1/Fw≤3.0 (1)

−1.2≤F3/F2≤−0.8 (2)

### CROSS REFERENCE TO RELATED APPLICATION

This application claims the benefit of Japanese Application No. 2021-107570 filed in Japan on Jun. 29, 2021, the contents of which are incorporated herein by this reference.

### BACKGROUND OF THE INVENTION

1. Field of the Invention

The present invention relates to a zoom lens and an image pickup apparatus including the zoom lens.

2. Description of Related Art

In recent years, an image pickup apparatus such as a so-called digital camera including an image pickup lens that forms an optical image of a desired target object (an object) and including a function of acquiring and recording, as electronic image data, the optical image of the target object formed by the image pickup lens has been generally widely adopted.

There are a lot of situations in which the image pickup apparatus of this type is mainly held in a hand and used by a user or is carried as baggage. Therefore, the image pickup apparatus of this type is always desired to be reduced in size and weight considering easiness of handling at a use time and at a carrying time, mobility, portability, and the like.

As the image pickup apparatus of this type of the related art, an image pickup apparatus of a so-called lens interchangeable type in which an image pickup lens is configured to be removably attachable to an apparatus main body has been generally widely adopted. When the lens interchangeable type image pickup apparatus of such a form is used, as a method of use generally carried out, for example, a user moves carrying a plurality of image pickup lenses and, in a site where the image pickup apparatus is actually used, selects a desired image pickup lens matching a purpose of use out of the carried plurality of image pickup lenses, attaches the desired image pickup lens to the apparatus main body and uses the desired image pickup lens, and repeats an image pickup operation while interchanging the image pickup lenses as appropriate. Therefore, the image pickup lens and the image pickup apparatus of this type of the related art are always desired to be reduced in size and weight considering convenience in the main use form explained above.

In general, it is well known that, for example, a reduction in size of an optical system configuring an image pickup lens is necessary in order to realize a reduction in size and weight of the image pickup lens. For example, when considering satisfying a demand to pick up a larger image of a more distant object, it is also well known that the optical system of the image pickup lens tends to be increased in size.

On the other hand, in recent years, an image pickup lens including an image pickup optical system configured to be able to continuously freely change a focal length within a predetermined range (a so-called zoom lens) has been generally widely adopted while an attention is directed to convenience at a use time. However, in general, the zoom lens tends to be increased in size and weight as improvement of functions through an increase in a variable magnification, an increase in speed, and the like is advanced.

More specifically, for example, in a so-called telephoto zoom lens that can freely change a focal length within a desired range in a focal length region longer than a focal length region of an image pickup lens having a so-called standard angle of view (a so-called standard lens), as speed is increased (that is, brighter specifications are adopted or a maximum aperture is set to a smaller value), a maximum diameter (an effective aperture) of a plurality of element lenses configuring an image pickup optical system increases and the number of element lenses configuring the zoom lens tends to increase. As a result, an overall size (an aperture, a total length, and the like) of the zoom lens tends to increase and weight of the zoom lens tends to increase. In this way, in the telephoto zoom lens of the related art, as improvement of functions is advanced, portability and mobility tend to be deteriorated.

For example, a zoom lens disclosed by Japanese Patent Application Laid-Open Publication No. 2016-80717 and the like includes, in order from an object side, a first lens group having positive refractive power, a second lens group having negative refractive power, a third lens group having positive refractive power, and a fourth lens group having negative refractive power. A maximum aperture on a long focus side (a telephoto side) is set to a small value of approximately 2.9 or 4.1 to increase speed over an entire zoom region to thereby realize improvement of functions.

Therefore, in the telephoto zoom lens of the related art, as means for realizing improvement of functions and a reduction in size through an increase in a variable magnification, for example, means for setting a maximum aperture on a long focus side (a telephoto side) to a large value (for example, F5.6 or more) to realize a reduction in diameter at a slight sacrifice of brightness is well known. In the case of this configuration, a reduction in size, an improvement effect of portability, and reserve power of performance obtained by the reduction in diameter can be allocated to a reduction in an entire length of the optical system.

For example, a zoom lens disclosed by International Publication No. WO2018/066648 and the like includes, in order from an object side, a first lens group having positive refractive power, a second lens group having negative refractive power, a third lens group having positive refractive power, and a fourth lens group having negative refractive power. A maximum aperture on a long focus side (a telephoto side) is set to approximately 6.35 to realize a zoom lens having a high variable magnification, while the zoom lens is small in size.

### SUMMARY OF THE INVENTION

A zoom lens according to an aspect of the present invention includes: in order from an object side, a first lens group having a positive focal length; a second lens group having a negative focal length; a third lens group including an aperture stop and having a positive focal length; a fourth lens group having a negative focal length; and a rear side lens group. The first lens group includes a negative lens and a. positive lens disposed in order from a most object side. The first lens group and the third lens group are fixed in power varying from a wide angle end to a telephoto end. The second lens group moves from the object side to an image side in the power varying. The zoom lens satisfies following conditional expressions (1) and (2).

2.1≤F1/Fw≤3.0 (1)

−1.2≤F3/F2≤−0.8 (2)

where,
F1 is a fiscal length of the first lens group,
Fw is a focal length at infinity of the wide angle end of the zoom lens,
F2 is a focal length of the second lens group, and
F3 is a focal length of the third lens group.

An image pickup apparatus according to an aspect of the present invention includes: the zoom lens; and an image pickup device configured to convert an optical image formed on an image pickup surface by the zoom lens into an electric signal.

Benefits of the present invention will be further clarified from following detailed explanation.

### BRIEF DESCRIPTION OF THE DRAWINGS

FIG. 1A is a sectional view of an optical system at a wide angle end of a zoom lens in an example 1;

FIG. 1B is a sectional view of the optical system in an intermediate focal length position of the zoom lens in the example 1;

FIG. 1C is a sectional view of the optical system at a telephoto end of the zoom lens in the example 1;

FIG. 2A is a sectional view of an optical system at a wide angle end of a zoom lens in an example 2;

FIG. 2B is a sectional view of the optical system in an intermediate focal length position of the zoom lens in the example 2;

FIG. 2C is a sectional view of the optical system at a telephoto end of the zoom lens in the example 2;

FIG. 3A is a sectional view of an optical system at a wide angle end of a zoom lens in an example 3;

FIG. 3B is a sectional view of the optical system in an intermediate focal length position of the zoom lens in the example 3;

FIG. 3C is a sectional view of the optical system at a telephoto end of the zoom lens in the example 3;

FIG. 4A is a sectional view of an optical system at a wide angle end of a zoom lens in an example 4;

FIG. 4B is a sectional view of the optical system in an intermediate focal length position of the zoom lens in the example 4;

FIG. 4C is a sectional view of the optical system at a telephoto end of the zoom lens in the example 4;

FIG. 5A is a sectional view of an optical system at a wide angle end of a zoom lens in an example 5;

FIG. 5B is a sectional view of the optical system in an intermediate focal length position of the zoom lens in the example 5;

FIG. 5C is a sectional view of the optical system at a telephoto end of the zoom lens in the example 5;

FIG. 6A is a sectional view of an optical system at a wide angle end of a zoom lens in an example 6;

FIG. 6B is a sectional view of the optical system in an intermediate focal length position of the zoom lens in the example 6;

FIG. 6C is a sectional view of the optical system at a telephoto end of the zoom lens in the example 6;

FIG. 7A is a sectional view of an optical system at a wide angle end of a zoom lens in an example 7;

FIG. 7B is a sectional view of the optical system in an intermediate focal length position of the zoom lens in the example 7;

FIG. 7C is a sectional view of the optical system at a telephoto end of the zoom lens in the example 7;

FIG. 8A is a sectional view of an optical system at a wide angle end of a zoom lens in an example 8;

FIG. 8B is a sectional view of the optical system in an intermediate focal length position of the zoom lens in the example 8;

FIG. 8C is a sectional view of the optical system at a telephoto end of the zoom lens in the example 8;

FIG. 9A, FIG. 9B, FIG. 9C, FIG. 9D, FIG. 9E, FIG. 9F, FIG. 9G, FIG. 9H, FIG. 9I, FIG. 9J, FIG. 9K, and FIG. 9L are aberration diagrams of the optical system of the zoom lens in the example 1;

FIG. 10A, FIG. 10B, FIG. 10C, FIG. 10D, FIG. 10E, FIG. 10F, FIG. 10G, FIG. 10H, FIG. 10I, FIG. 10J, FIG. 10K, and FIG. 10L are aberration diagrams of the optical system of the zoom lens in the example 2;

FIG. 11A, FIG. 11B, FIG. 11C, FIG. 11D, FIG. 11E, FIG. 11F, FIG. 11G, FIG. 11H, FIG. 11I, FIG. 11J, FIG. 11K, and FIG. 11L are aberration diagrams of the optical system of the zoom lens in the example 3;

FIG. 12A, FIG. 12B, FIG. 12C, FIG. 12D, FIG. 12E, FIG. 12F, FIG. 12G, FIG. 12H, FIG. 12I, FIG. 12J, FIG. 12K, and FIG. 12L are aberration diagrams of the optical system of the worn lens in the example 4;

FIG. 13A, FIG. 13B, FIG. 13C, FIG. 13D, FIG. 13E, FIG. 13F, FIG. 13G, FIG. 13H, FIG. 13I, FIG. 13J, FIG. 13K, and FIG. 13L are aberration diagrams of the optical system of the zoom lens in the example 5;

FIG. 14A, FIG. 14B, FIG. 14C, FIG. 14D, FIG. 14E, FIG. 14F, FIG. 14G, FIG. 14H, FIG. 14I, FIG. 14J, FIG. 14K, and FIG. 14L are aberration diagrams of the optical system of the zoom lens in the example 6;

FIG. 15A, FIG. 15B, FIG. 15C, FIG. 15D, FIG. 15E, FIG. 15F, FIG. 15G, FIG. 15H, FIG. 15I, FIG. 15J, FIG. 15K, and FIG. 15L are aberration diagrams of the optical system of the zoom lens in the example 7;

FIG. 16A, FIG. 16B, FIG. 16C, FIG. 16D, FIG. 16E, FIG. 16F, FIG. 16G, FIG. 16H, FIG. 16I, FIG. 16J, FIG. 16K, and FIG. 16L are aberration diagrams of the optical system of the zoom lens in the example 8;

FIG. 17 is a conceptual diagram showing a schematic configuration of an image pickup apparatus in an embodiment of the present invention;

FIG. 18 is a schematic perspective view mainly showing a front surface side of the image pickup apparatus in the embodiment of the present invention;

FIG. 19 is a schematic perspective view mainly showing a rear surface side of the image pickup apparatus in the embodiment of the present invention; and

FIG. 20 is a block configuration diagram mainly showing an electric configuration in an internal configuration of the image pickup apparatus in the embodiment of the present invention.

### DETAILED DESCRIPTION OF THE PREFERRED EMBODIMENTS

An increase in speed and improvement of functions of a general zoom lens can be realized over an entire zoom region by setting a maximum aperture on a long focus side (a telephoto side) to a small value. However, in such a zoom lens, the number of component lenses increases and the zoom lens increases in weight because of an increase in size. As a result, handling at a use time and at a carrying time tends to be difficult.

In a telephoto zoom lens among general zoom lenses, both of a reduction in size and an increase in variable magnification can be realized by setting a maximum aperture on a long focus side (a telephoto side) to a large value. However, if the maximum aperture on the long focus side (the telephoto side) is set large, for example, shutter speed at which proper exposure can be obtained decreases. For example, shutter speed that can be set at a use time (at a photographing time) decreases, so-called camera shake, object shake, or the like easily occurs. Therefore, problems occurs in that, for example, it is difficult to obtain an image pickup result intended by a user and a so-called shutter chance is missed.

Further, in some general telephoto zoom lens, for example, if zooming operation is performed at a use time, all of a plurality of lens groups move to an object side and a center of gravity position of the zoom lens changes. In the zoom lens having the configuration of this type, every time a user performs the zooming operation, the user needs to care about, according to the changing center of gravity position, holding an image pickup apparatus to which the zoom lens is attached. Accordingly, it is difficult for the user to continue to always stably hold the zoom lens and the image pickup apparatus. Therefore, it is likely that a feeling of use of the zoom lens and the image pickup apparatus is hindered, for example, the user cannot concentrate on image pickup operation.

Therefore, in particular, in the telephoto zoom lens, for example, even when the user performs the zooming operation or the like, it is desirable that a total length of the telephoto zoom lens does not change.

Therefore, according to an embodiment of the present invention explained below, it is possible to provide a bright and high performance zoom lens having a zoom function that can freely change a focal length and including a telephoto zoom optical system, an entire length of which is not changed by zooming operation, aberrations of which are satisfactorily corrected while a reduction in size is realized, and in particular, a maximum aperture on a long focus side (a telephoto side) of which is set small, and an image pickup apparatus including the zoom lens,

The present invention is explained below with reference to an illustrated embodiment.

Prior to explanation of respective examples of the present invention, action effects of an embodiment including an aspect of the present invention are explained. Note that when the action effects of the embodiment of the present invention is explained, a specific example is shown and explained, However, as in the case of the respective examples explained below, an illustrated aspect is only a part of aspects included in the present invention, A lot of variations are present in the aspect. Therefore, the aspects of the present invention are not limited to the aspect illustrated below.

First, a basic configuration of a zoom lens in an embodiment of the present invention is explained.

The basic configuration of the zoom lens in the present embodiment includes, in order from an object side, a first lens group having a positive focal length, a second lens group having a negative focal length, a third lens group including an aperture stop and having a positive focal length, a fourth lens group having a negative focal length, and a rear side lens group.

An optical system of a so-called telephoto type is configured by disposing the respective lens groups in the order of the lens groups having the positive focal lengths and the lens groups having the negative focal lengths from the object side, As a characteristic of the optical system of the telephoto type, a principal point is set further on the object side than a positive lens group on the object side. Consequently, the optical system of the telephoto type has an advantage that a total length of the zoom lens can be set shorter than an actual focal length. Therefore, the zoom lens in the present embodiment obtains an effect that the lens total length can be reduced by adopting the optical system of the telephoto type.

Further, a further reduction in the total length can he realized by providing, on an image side of the optical system having this configuration (two positive and negative lens groups on the object side), the same optical system of the telephoto type, that is, an optical system in which a lens group having a positive focal length and a lens group having a negative focal length are disposed in order from an object side.

In the zoom lens in the present embodiment, the first lens group is configured by disposing a negative lens and a positive lens in order from a most object side. The first lens group is a lens group disposed on the most object side in the zoom lens. Therefore, in the first lens group, in particular, a chromatic aberration needs to be minimized. The reason is because the chromatic aberration that occurs in the first lens group is enlarged by a lens group further on the image side than the first lens group. In order to obtain satisfactory imaging performance in the entire zoom lens, necessity of selecting a glass material that can minimize the chromatic aberration in the first lens group is demanded.

In general, in a lens group having a positive focal length, a chromatic aberration can be reduced by using a glass material having a large Abbe number in a convex lens and using a glass material having a small Abbe number in a concave lens. However, it is known that the glass material having the large Abbe number is easily scratched. Accordingly, when. the convex lens is disposed on the most object side, an outer surface of the lens to be easily scratched is exposed to an outside. Accordingly, it is known that handleability (handling) at a use time tends to be deteriorated. Therefore, a glass material having a relatively small Abbe number tends to be selected as a glass material adopted in the convex lens disposed on the most object side. As a result, a problem occurs in that the chromatic aberration increases,

Therefore, the zoom lens in the present embodiment adopts a configuration in which a lens disposed on a most object side is a concave lens in which a glass material having a small Abbe number can be used and a convex lens in which a glass material having a large Abbe number is used is disposed further on an image side than the concave lens. By adopting this configuration, the zoom lens in the present embodiment is satisfactory in handleability at a use time and realizes a reduction in a chromatic aberration.

The zoom lens in the present embodiment has a configuration in Which the first lens group and the third lens group are fixed in zooming from a most wide angle end that can be set (hereinafter simply referred to as wide angle end) to a most telephoto end that can be set (hereinafter simply referred to as telephoto end) and the second lens group moves from the object side to the image side in the zooming.

The first lens group is a lens group having a largest diameter and a largest weight in an image pickup optical system configuring the zoom lens in the present embodiment. It is possible to reduce a changing center of gravity position at a zooming time by fixing the first lens group at the zooming time. Therefore, it is possible to provide a suitable use environment without hindering an operation feeling of the user.

Further, by adopting the configuration in which the first lens group is fixed, it is possible to realize a configuration in which it is easy to suppress intrusion of dust, droplets, and the like from the outside into a lens barrel functioning as a housing member of the zoom lens.

The third lens group is fixed at the zooming time and configured to integrate the second lens group as a moving lens. With this configuration, a driving mechanism and the like (not illustrated) provided in the lens barrel can be simplified. Therefore, such a configuration can contribute to a reduction in size and a reduction in weight of the entire zoom lens. In this case, the second lens group moves from the object side to the image side to thereby function as a zoom lens group.

A lens group disposed on a most image side in a rear side lens group is desirably fixed at the zooming time. By adopting such a configuration, just like the effects obtained by fixing the first lens group, it is possible to make it easy to suppress dust, droplets, and the like from entering the lens barrel from the outside.

As explained above, the configuration in which the lens group on the most image side in the rear side lens group is fixed is a form advantageous for configuring the lens barrel having a substantially sealed structure. If such a lens barrel of the sealed structure is configured, it is possible to suppress noise such as various kinds of operation noise that occur inside the lens barrel when the zoom lens is operated, for example, at a focusing operation time. This can contribute to improvement of video quality, for example, when so-called moving image photographing with voice or the like for recording environment sound simultaneously with acquisition of a video is performed.

Note that the zoom lens in the present embodiment is desirably a type that collapses when not in use, for example, at a carrying time and at a storage time. The collapsible type can realize a reduction in size, in particular, in a lens total length direction when the zoom lens is not used, for example, at the carrying time and at the storage time. Therefore, it is possible to contribute to improvement of convenience. In particular, in the configuration of the zoom lens in the present embodiment, the first lens group and the third lens group are fixed. Therefore, a configuration for collapsing a space from the first lens group to the third lens group can be realized only by a simple mechanism while maintaining a diameter of the lens barrel.

Further, the zoom lens in the present embodiment satisfies a following conditional expressions (1) and (2).

2.1≤F1/Fw≤3.0 (1)

−1.2≤F3/F2≤−0.8 (2)

where,
F1 is a focal length of the first lens group,
Fw is a focal length at infinity of the wide angle end of the zoom lens,
F2 is a focal length of the second lens group, and
F3 is a focal length of the third lens group.

The conditional expression (1) is an expression obtained by standardizing the focal length of the first lens group with the focal length at the wide angle end of the zoom lens, A small and high performance zoom lens can be configured by satisfying the conditional expression (1).

If an upper limit value is exceeded in the conditional expression (1), the focal length of the first lens group becomes excessively long. The focal length of the first lens group greatly affects the entire length of the zoom lens. Therefore, if the focal length of the first lens group increases, a reduction in size of the zoom lens is hindered.

If a lower limit value is exceeded in the conditional expression (1), the focal length of the first lens group becomes excessively short. As a result, aberrations (in particular, a chromatic aberration) that occur in the first lens group cannot be satisfactorily corrected. Therefore, improvement of performance of the zoom lens is hindered.

The lower limit value of the conditional expression (1) is preferably set to 2.15. The lower limit value is more preferably set to 2.2.

The upper limit value of the conditional expression (1) is preferably set to 2.9. The upper limit value is more preferably set to 2.7.

The conditional expression (2) represents a ratio of the focal lengths of the third lens group and the second lens group. A small and high performance zoom lens can be configured by satisfying the conditional expression (2).

If an upper limit value is exceeded in the conditional expression (2), the focal length of the second lens group becomes excessively long, Therefore, when it is attempted to configure a zoom lens set to a predetermined zoom ratio, an entire length of the zoom length is large. Consequently, a reduction in size of the zoom lens is hindered.

If a lower limit value is exceeded in the conditional expression (2), the focal length of the second lens group becomes excessively short. Therefore, aberrations that occur in the second lens group cannot be satisfactorily corrected. Therefore, improvement of performance of the zoom lens is hindered.

The lower limit value of the conditional expression (2) is preferably set to 1.15. The lower limit value is more preferably set to −1.1.

The upper limit value of the conditional expression (2) is preferably set to 0.85. The upper limit value is more preferably set to −0.9.

In the zoom lens in the present embodiment, further, the fourth lens group moves at a focusing time and one or more positive lenses and one or more negative lenses are included.

The fourth lens group has a lens configuration in which the positive lenses and the negative lenses are disposed in order from an object side. With this configuration, an effective diameter of the fourth lens group can be set smaller than effective diameters of the other lens groups. Therefore, it is possible to contribute to a reduction in weight of the fourth lens group.

The fourth lens group can suppress occurrence of an axial aberration. Therefore, improvement of performance can be secured to a closest distance by using the fourth lens group as a focusing lens group. Further, in the fourth lens group in the optical system of the present invention, focus sensitivity (that is, an amount of change in a focus position at the time when a certain lens group moves in a direction along an optical axis) can be set high. Therefore, by configuring the fourth lens group in this way, it is possible to reduce respective movement amounts at a focusing time from the infinity to the closest distance and at the focusing time from the closest distance to the infinity.

The fourth lens group is desirably a wobbling group. Since the rear side lens group is disposed on the image side of the fourth lens group having the negative focal length, when a focusing operation is performed, a change in an incident height of a main beam of an off-axis beam can be reduced. Therefore, magnification fluctuation due to the focusing operation can be suppressed. This configuration enables acquisition of a high quality movie with less magnification fluctuation, for example, at a moving image photographing time.

By configuring the fourth lens group with at least one positive lens and one negative lens, a chromatic aberration that occurs in the fourth lens group can be minimized and fluctuation in an axial chromatic aberration from the infinity to a closest state in respective zoom states can be reduced. Note that the negative lens and the positive lens are more desirably configured as one bonded lens.

In the zoom lens in the present embodiment, further, in the second lens group, a lens on the most object side is a positive lens.

The second lens group is a lens group acting as a zoom group in the zoom lens in the present embodiment. A mechanism of the lens group functioning as the zoom group can be further simplified as an effective diameter is smaller. Therefore, a reduction in a diameter of the zoom group can reduce a diameter of the lens barrel and, therefore, can contribute to a reduction in size of the zoom lens itself

By disposing the positive lens on the most object side of the second lens group, a diameter of a lens group disposed further on the image side than the positive lens can be reduced. Therefore, a diameter of the second lens group can be reduced. Further, by reducing the diameter of the second lens group, a diameter of the third lens group can also he reduced. The third lens group is a lens group including an aperture stop. Therefore, reducing the second lens group in size also leads to a reduction in an opening diameter for setting a predetermined F value. By reducing the opening diameter, a reduction in size of an aperture unit can be realized. This can contribute to a reduction in size of the entire zoom lens. Therefore, a reduction in size of the lens barrel can also be realized.

In the zoom lens in the present embodiment, further, the second lens group includes three bonded lenses bonded in the order of a positive lens, a negative lens, and a positive lens from the object side.

Since the second lens group includes the three bonded lenses bonded in the order of the positive lens, the negative lens, and the positive lens from the object side, a reduction in size of the second lens group can be realized, Since the lens barrel reduced in size can be realized, a zoom lens in which, in particular, a comatic aberration and a chromatic aberration at a telephoto end are satisfactorily corrected can be configured.

Further, a reason for bonding the positive lens on the most object side with the negative lens on the image side in the second lens group is as follows. By disposing the positive lens on the most object side of the second lens group, a diameter of a lens group disposed further on the image side than the positive lens can be reduced. Therefore, a diameter of the second lens group can be reduced. Further, by reducing the diameter of the second lens group, the diameter of the third lens group can also be reduced. By bonding these lenses, a chromatic aberration can be satisfactorily corrected.

The second lens group in the zoom lens in the present embodiment is configured to be able to more satisfactorily correct a chromatic aberration by further bonding the positive lens to the image side of the bonded lens in which the positive lens and the negative lens are bonded. The second lens group is a negative lens group. Therefore, a principal point position can he arranged on the object side by disposing the negative lens further on the object side. This leads to realization of a further reduction in size in the zoom lens set to the predetermined zoom ratio. Therefore, it is more preferable for a reduction in size to dispose the negative lens and the positive lens in order from the object side. In this case, a configuration in which the positive lens is bonded on the most image side can suppress a comatic aberration divided for each color at the telephoto end that occurs on a bonding surface on the object side.

As explained above, in the zoom lens in the present embodiment, the second lens group has the configuration including the three bonded lenses bonded in the order of the positive lens, the negative lens, and the positive lens from the object side. Therefore, it is possible to realize a reduction in size of the second lens group and, therefore, realize a reduction in size of the lens barrel and, at the same time, it is possible to realize the zoom lens in which, in particular, a comatic aberration and a chromatic aberration at the telephoto end are satisfactorily corrected.

In the zoom lens in the present embodiment, a lens disposed on the most object side in the third lens group is a positive lens. The zoom lens satisfies a following conditional expression (3).

vdG3F≥45 (3)

where vdG3F is an Abbe number on a d line of the positive lens disposed on the most object side of the third lens group.

Since the positive lens is disposed on the most object side, the third lens group can contribute to a reduction in size of the zoom lens set to the predetermined zoom ratio.

The third lens group is a lens group having a positive focal length. The principal point position can be arranged on the object side by disposing the positive lens on the object side of the third lens group. Since efficient zooming can be performed by arranging the principal point position on the object side in this way, it is possible to contribute to a reduction in size of the zoom lens set to the predetermined zoom ratio.

The conditional expression (3) represents a range of the Abbe number on the d line of the positive lens disposed on the most object side of the third lens group. The focal length of the third lens group needs to he set short in order to reduce a total length of the zoom lens. However, if the focal length of the lens group is set short, there is a problem in that an axial chromatic aberration on a telephoto end side occurs. It is possible to satisfactorily correct a chromatic aberration by using a glass material having a large Abbe number in the positive lens. Therefore, in the zoom lens in the present embodiment, by setting the positive lens disposed on the most object side of the third lens group to satisfy the conditional expression (3), it is possible to satisfactorily correct the chromatic aberration and contribute to a reduction in size of the zoom lens.

If a lower limit value is exceeded in the conditional expression (3), an axial chromatic aberration cannot be satisfactorily corrected. Therefore, in that case, it is difficult to obtain a high performance zoom lens.

Note that, in the third lens group, an aspherical lens is desirably adopted as the positive lens disposed on the most object side. By adopting the aspherical lens as the positive lens, it is possible to satisfactorily correct a spherical aberration and a comatic aberration. Therefore, it is possible to configure a higher performance zoom lens,

In the conditional expression (3), the lower limit value is preferably set to 48. The lower limit value is more preferably set to 55.

In the zoom lens in the present embodiment, a lens disposed on the most image side in the third lens group is a positive lens. The zoom lens satisfies a following conditional expression (4).

vdG3R≥60 (4)

where, vdG3R is an Abbe number on a d line of the positive lens disposed on the most image side in the third lens group.

The conditional expression (4) represents a range of the Abbe number on the d line of the positive lens disposed on the most image side in the third lens group.

As explained above, the focal length of the third lens group needs to be set short in order to reduce the total length of the zoom lens. However, if the focal length of the lens group is set short, there is a problem in that an axial chromatic aberration on a telephoto end side occurs. It is possible to satisfactorily correct a chromatic aberration by using a glass material having a large Abbe number in the positive lens, Therefore, in the zoom lens in the present embodiment, by setting the positive lens disposed on the most image side of the third lens group to satisfy the conditional expression (4), it is possible to satisfactorily correct the chromatic aberration and contribute to a reduction in size of the zoom lens.

If a lower limit value is exceeded in the conditional expression (4), an axial chromatic aberration cannot be satisfactorily corrected. Therefore, in that case, it is difficult to obtain a high performance zoom lens.

In the conditional expression (4), the lower limit value is preferably set to 63. The lower limit value is more preferably set to 66.

The zoom lens in the present embodiment further satisfies a following conditional expression (5).

−5≤(1−(β4W)²)×(βRW)²≤−3 (5)

where,
β4W is a lateral magnification at a wide angle end of the fourth lens group, and
βRW is a lateral magnification at a wide angle end of the rear side lens group.

The conditional expression (5) represents focus sensitivity of the fourth lens group (an amount of change in a focus position at the time when the fourth lens group moves on an optical axis) at the wide angle end of the zoom lens.

The fourth lens group is the lens group optimum as the focusing lens group as explained above. Therefore, the fourth lens group can more inexpensively configure a zoom lens that satisfies the conditional expression (5) to thereby facilitate focusing control, has light weight and short total length, and can obtain photographing magnification at a predetermined closest distance.

An upper limit value being exceeded in the conditional expression (5) means that the focus sensitivity decreases. If the focus sensitivity decreases, a focusing distance becomes long in the focusing from the infinity to the closest distance end. This leads to an increase in the entire length of the entire zoom lens. Therefore, it is difficult to reduce the zoom lens in size.

A lower limit value being exceeded in the conditional expression (5) means that the focus sensitivity increases. If the focus sensitivity increases, stop accuracy at a focusing time is a problem. In an image pickup lens, in order to improve stop accuracy at the focusing time, for example, it is desirable to perform focusing driving using a voice coil motor (hereinafter abbreviated as VCM).

However, when the VCM is adopted, focusing control is complicated and weight increases. In addition, there is a problem in that a component price is high. In particular, it is well known that an increase in price of the image pickup lens does not match a demand of the user.

Therefore, by configuring the fourth lens group within a range in which the conditional expression (5) is satisfied, it is possible to adopt a driving source that is more easily controlled and is light in weight and inexpensive (for example, a stepping motor; hereinafter abbreviated as STM). Therefore, it is possible to configure a zoom lens for which focusing control is easily performed and that is light in weight and inexpensive,

In the conditional expression (5), the upper limit value is preferably set to −3.3. The upper limit value is more preferably set to −3.4.

In the conditional expression (5), the lower limit value is preferably set to −4.8. The lower limit value is more preferably set to −4.6.

The zoom lens in the present embodiment further satisfies a following conditional expression (6).

−2.0≤F4RW/FW≤−0.8 (6)

where,
F4RW is a combined focal length from the fourth lens group to a wide angle end of a lens group on the image side, and
FW is a focal length at a wide angle end of the zoom lens.

The conditional expression (6) is obtained by standardizing the combined. focal length from the fourth lens group to the wide angle end of the lens group on the image side with the focal length (at an infinity focus time) at the wide angle end of the zoom lens.

In the zoom lens in the present embodiment, as explained above, a reduction in size of the telephoto zoom lens is realized by disposing, in order from the object side, the first lens group having the positive focal length, the second lens group having the negative focal length, the third lens group having the positive focal length, and the fourth lens group having the negative focal length. The rear side lens group is disposed on the image side of the fourth lens group. In order to maximize action effects obtained by the configuration of the zoom lens in the present embodiment, that is, the configuration in which the lens groups are disposed in the order of positive, negative, positive, and negative from the object side, for example, the zoom lens needs to be configured to have a negative focal length as the combined focal length of the lens groups from the fourth lens group to the lens group on the image side as well.

Therefore, by setting the zoom lens to satisfy the conditional expression (6), it is possible to configure a telephoto zoom lens in which a reduction in size is realized and various aberrations (in particular, a curvature of field) is satisfactorily corrected.

If an upper limit value is exceeded in the conditional expression (6), the combined focal length from the fourth lens group to the wide angle end of the lens group on the image side decreases. Then, the various aberrations (in particular, the curvature of field) cannot be satisfactorily corrected. Therefore, it is difficult to improve performance of the zoom lens.

If a lower limit value is exceeded in the conditional expression (6), the combined focal length from the fourth lens group to the wide angle end of the lens group on the image side increases. Then, the action effects obtained by the basic configuration of the zoom lens in the present embodiment, that is, the configuration in which the positive, negative, positive, and negative lens groups are disposed in order from the object side diminish. Therefore, it is difficult to reduce the zoom lens in size.

In the conditional expression (6), the upper limit value is preferably set to −0.83. The upper limit value is more preferably set to −0.88.

In the conditional expression (6), the lower limit value is preferably set to −1.8. The lower limit value is more preferably set to −1.6.

An image pickup apparatus in the present embodiment includes a zoom optical system configuring a zoom lens and an image pickup device disposed on an image-forming plane. The image pickup device is a photoelectric conversion element that includes an image pickup surface parallel to the image-forming plane and converts an optical image of an object formed on the image pickup surface by the zoom optical system into an electric signal. The zoom lens in the present embodiment is adopted as the zoom optical system of the image pickup apparatus. With such a configuration, the image pickup apparatus in the present embodiment can acquire a high quality image.

As explained above, with the zoom lens in the embodiment, it is possible to realize a reduction in size without spoiling easiness of handling at a use time and at a carrying time and mobility and portability and without spoiling optical performance.

Since the image pickup apparatus in the embodiment includes the zoom lens in the embodiment, similarly, it is possible to acquire a high quality image and realize a reduction in size without spoiling easiness of handling at a use time and at a carrying time and mobility and portability.

The zoom lens and the image pickup apparatus including the zoom lens in the embodiment may simultaneously satisfy a plurality of configurations. This is preferable in obtaining a satisfactory zoom optical system and a satisfactory image pickup apparatus. A preferred combination of the configurations is optional. The respective conditional expressions may limit only the upper limit values or the lower limit values when numerical ranges of the conditional expressions are further limited.

Subsequently, a plurality of examples about the zoom lens of the present invention are explained in detail below with reference to the drawings. Note that the present invention is not limited by the examples.

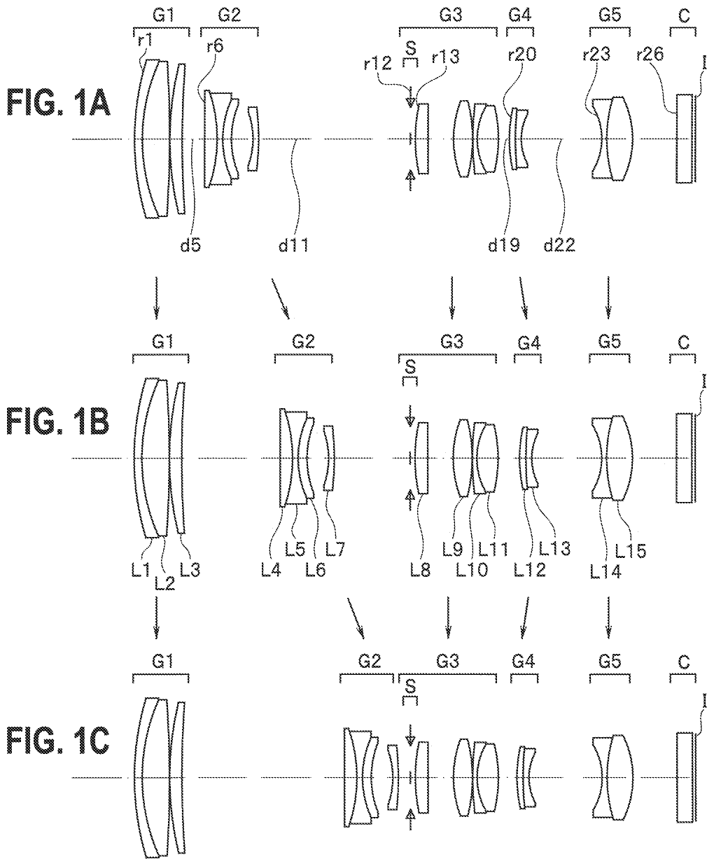

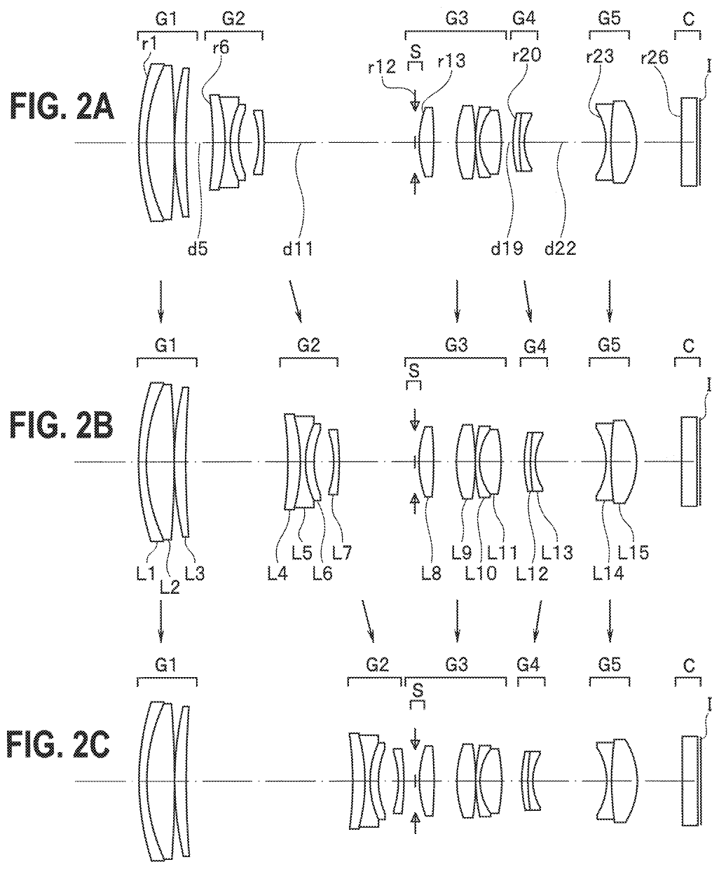

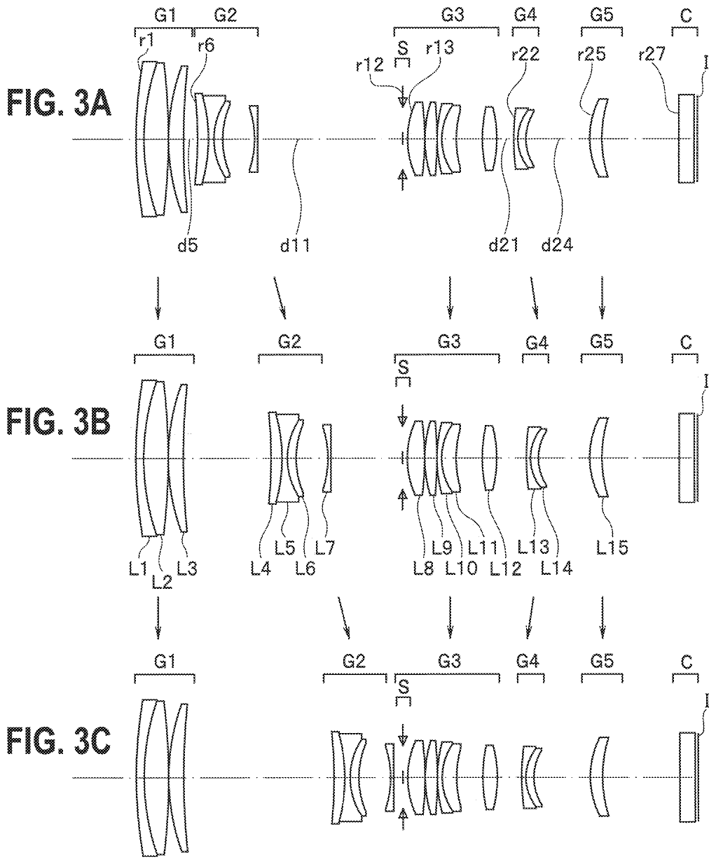

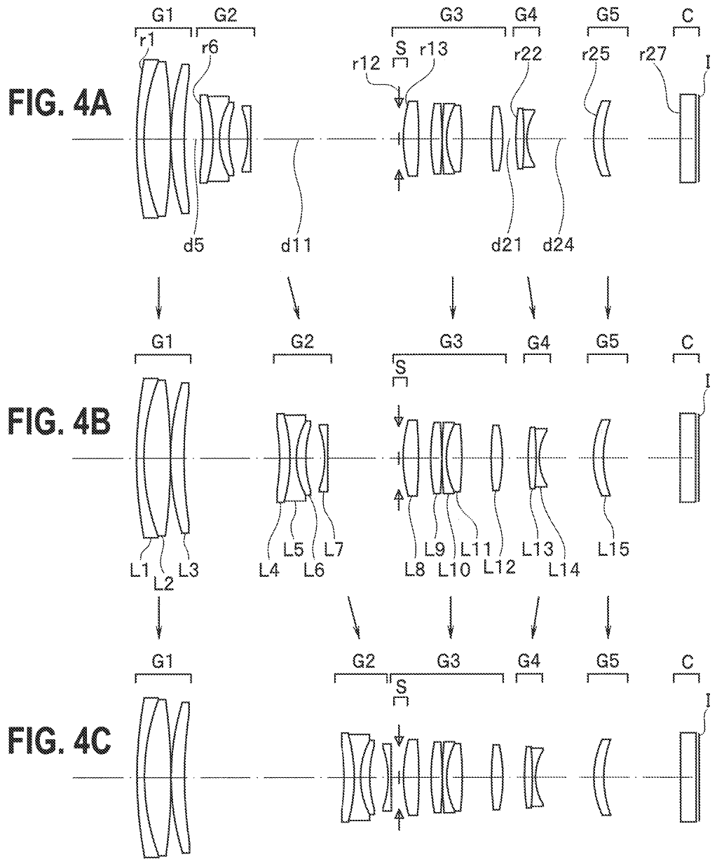

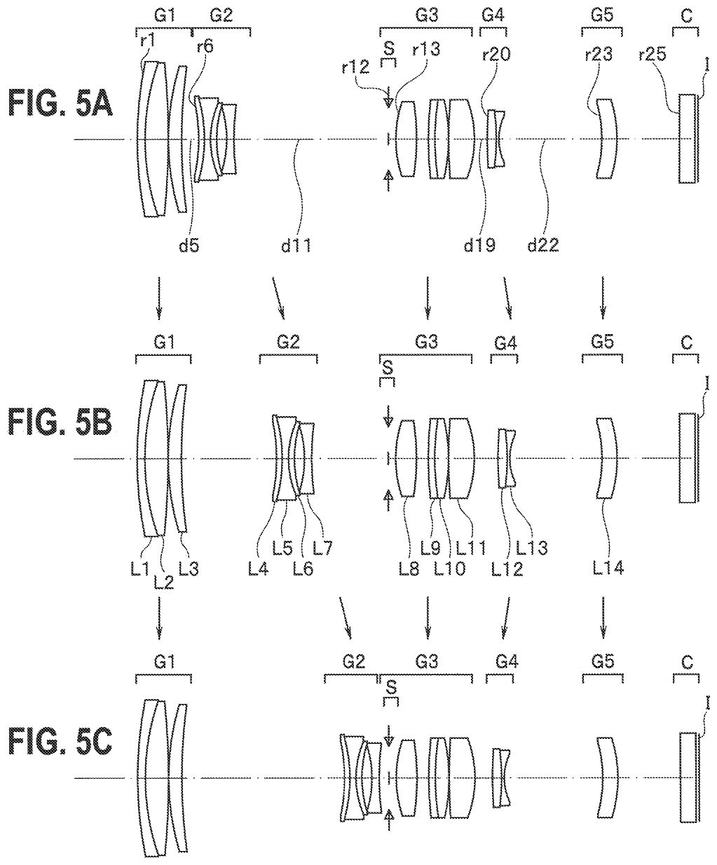

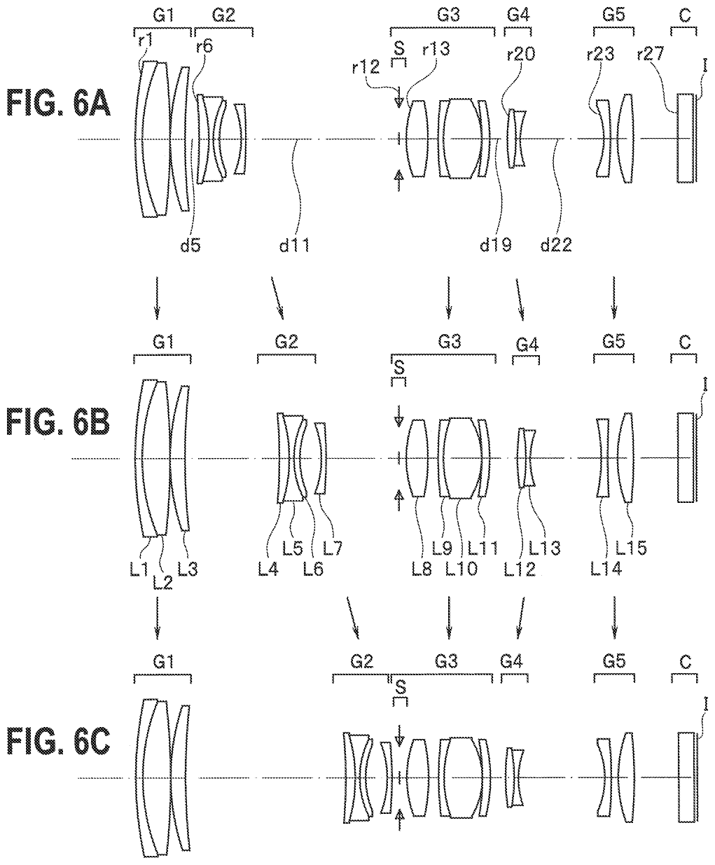

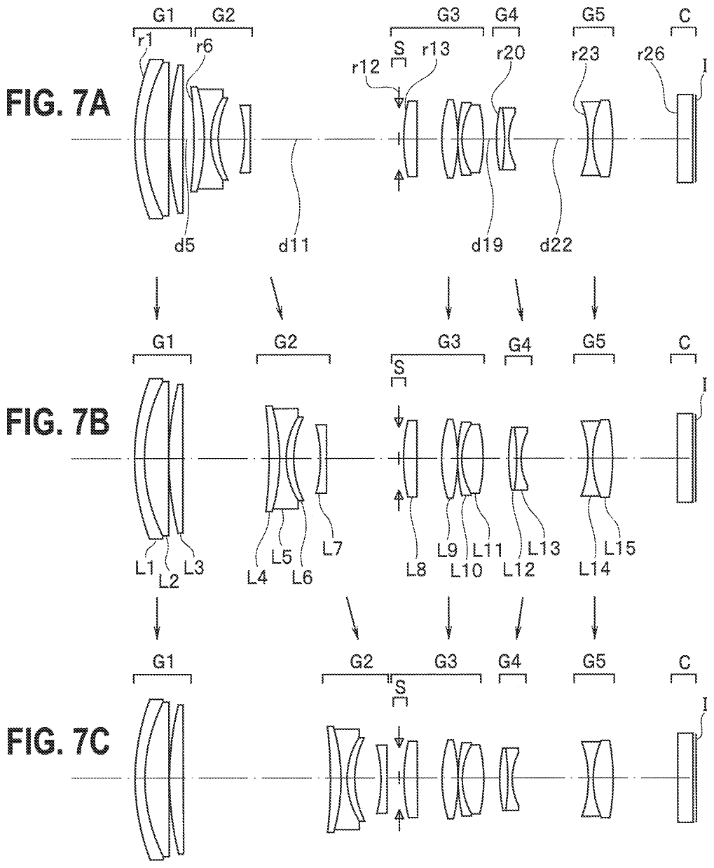

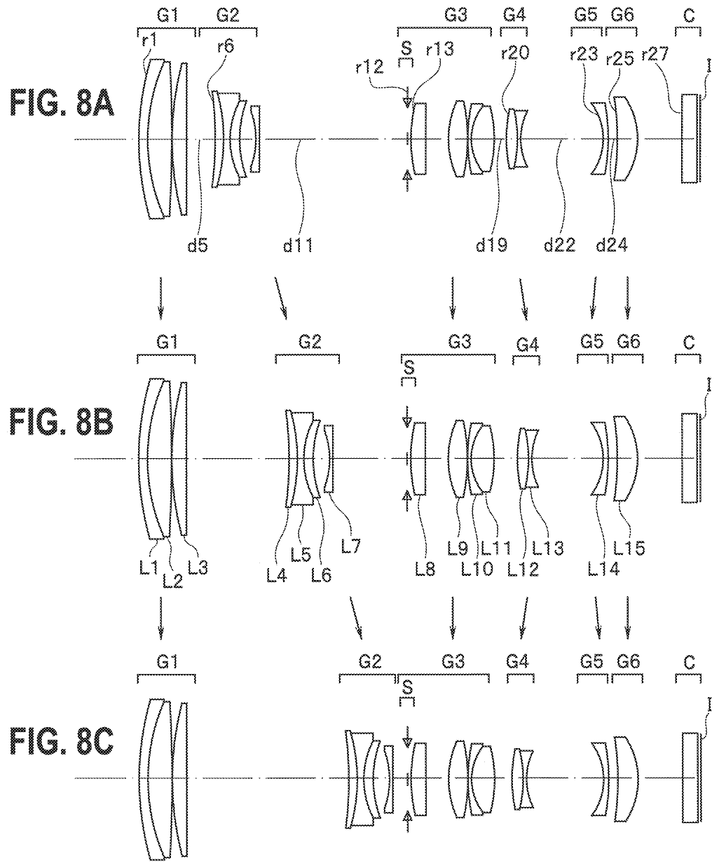

FIG. 1A, FIG. 1B, and FIG. 1C to FIG. 8A, FIG. 8B, and FIG. 8C are sectional views of optical systems of zoom lenses in examples 1 to 8 of the present invention. FIG. 1A, FIG. 2A, FIG. 3A, FIG. 4A, FIG. 5A, FIG. 6A, FIG. 7A, and FIG. 8A are respectively sectional views of the optical systems at a wide angle end. FIG. 1B, FIG. 2B, FIG. 3B, FIG. 4B, FIG. 5B, FIG. 6B, FIG. 7B, and FIG. 8B are respectively sectional views of the optical systems in an intermediate focal length position. FIG. 1C, FIG. 2C, FIG. 3C, FIG. 4C, FIG. 5C, FIG. 6C, FIG. 7C, and FIG. 8C are respectively sectional views of the optical systems at a telephoto end.

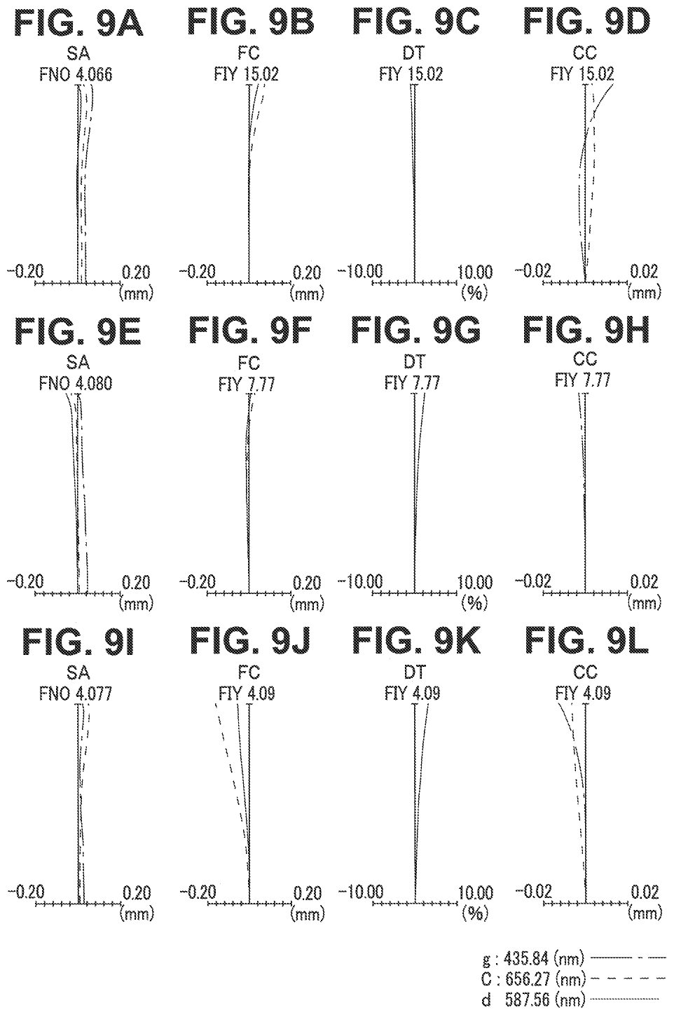

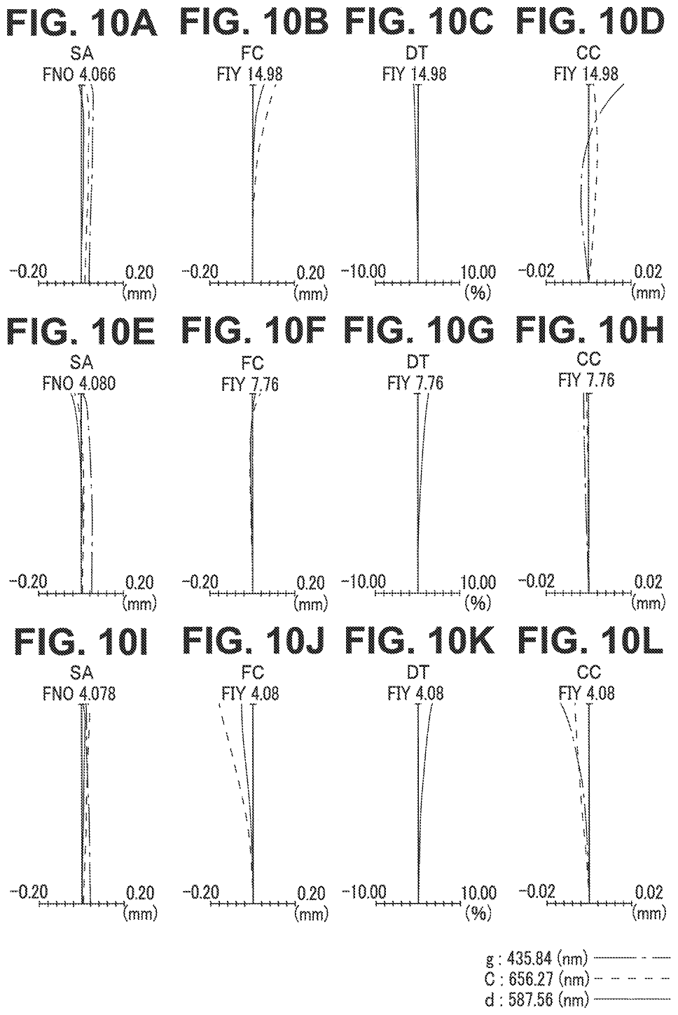

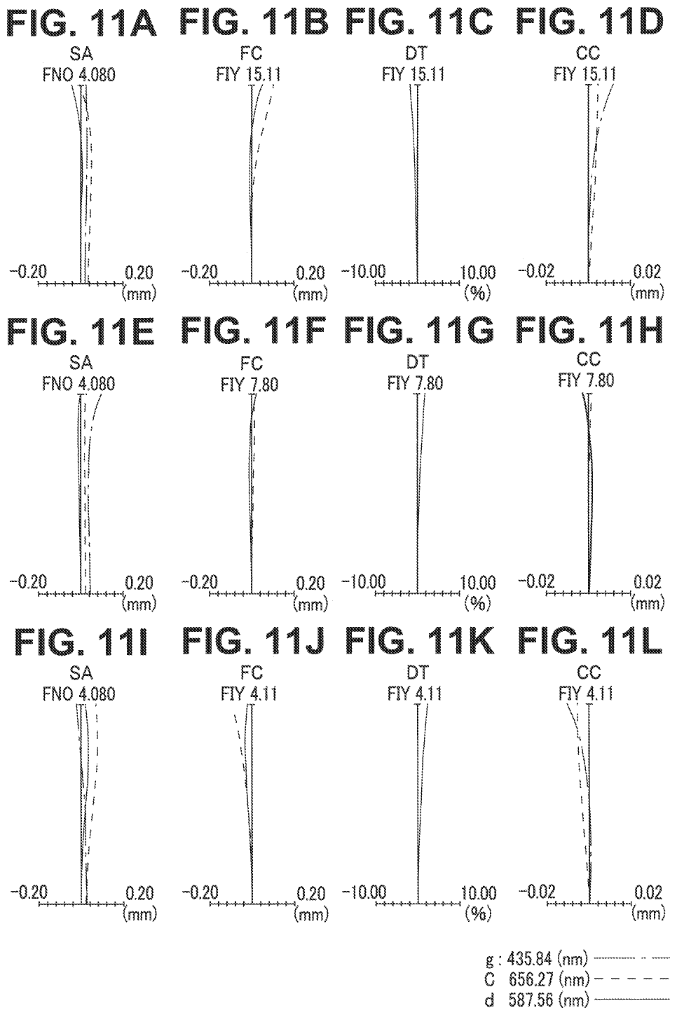

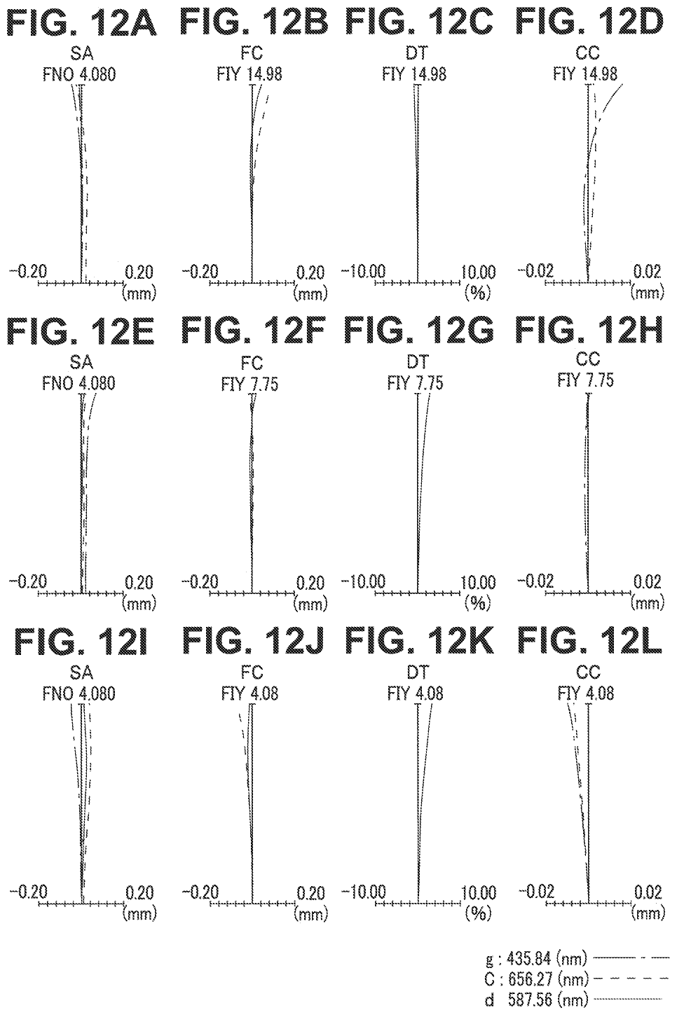

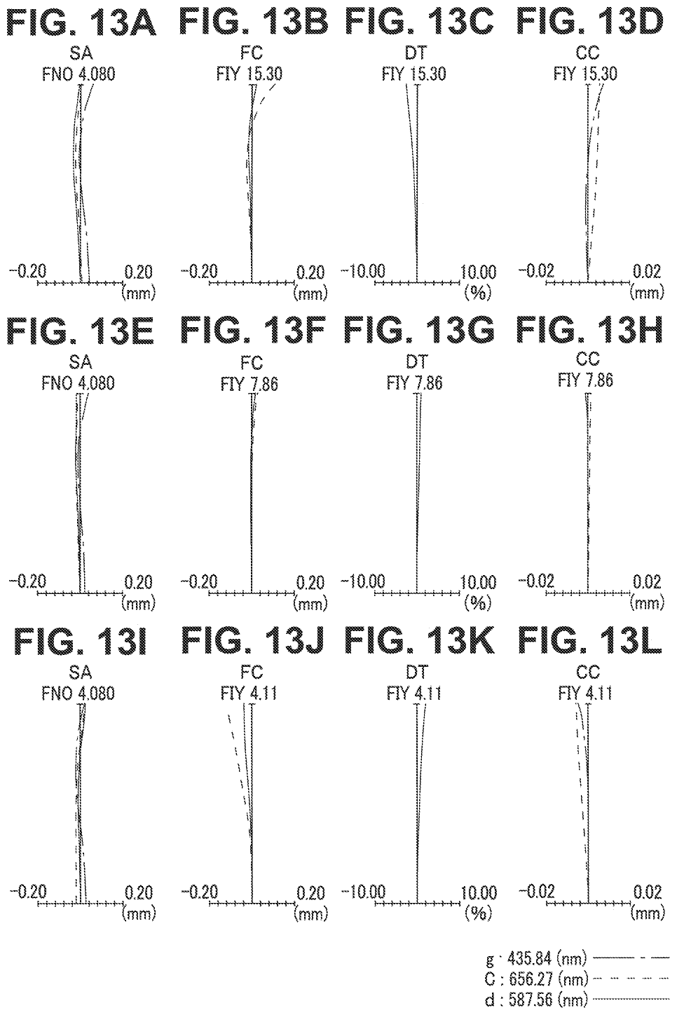

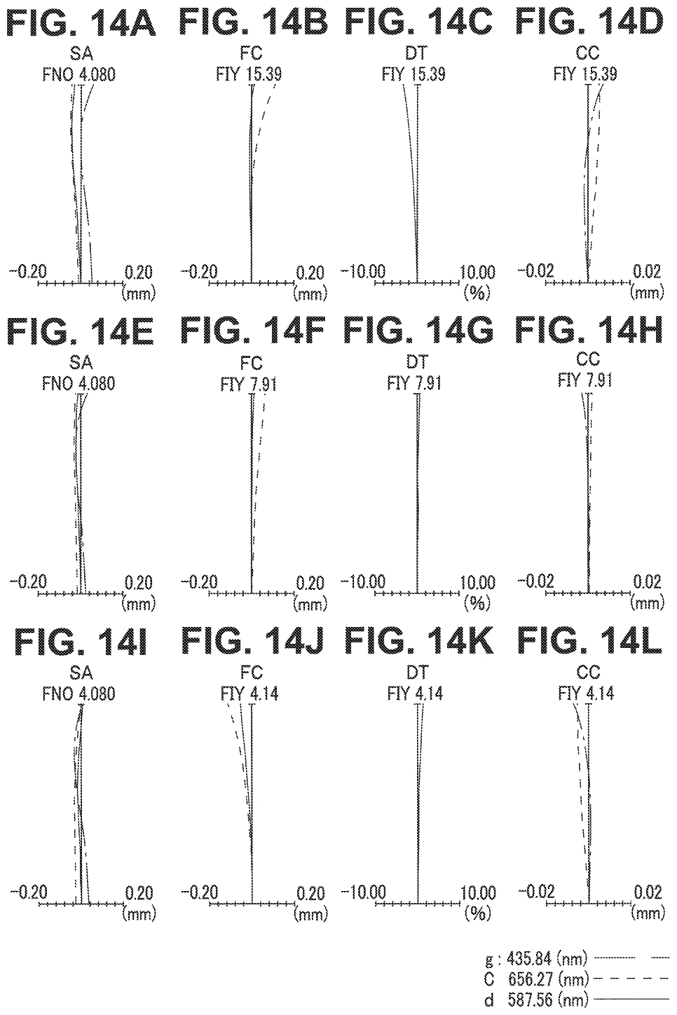

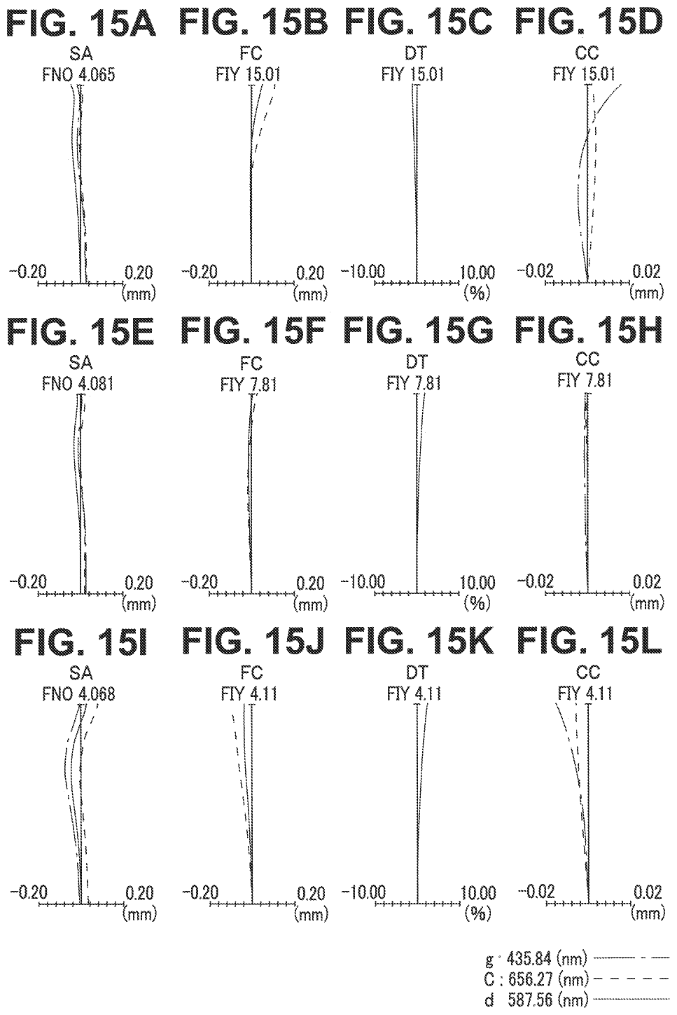

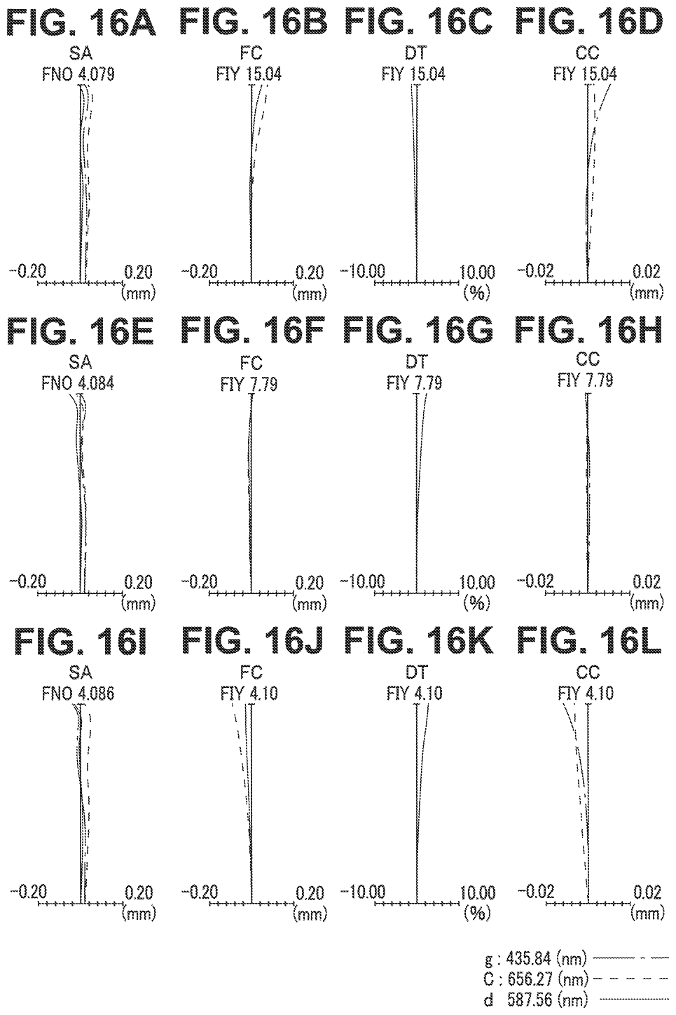

FIG. 9A, FIG. 9B, and FIG. 9C to FIG. 16A, FIG. 16B, and FIG. 16C are aberration diagrams of the optical systems of the zoom lenses in the examples 1 to 8 of the present invention. FIG. 9A, FIG. 10A, FIG. 11A, FIG. 12A, FIG. 13A, FIG. 14A, FIG. 15A, and FIG. 16A respectively show spherical aberrations (SA) at the wide angle end. FIG. 9B, FIG. 10B, FIG. 11B, FIG. 12B, FIG. 13B, FIG. 14B, FIG. 15B, and FIG. 16B respectively show astigmatisms (AS)at the wide angle end. FIG. 9C, FIG. 10C, FIG. 11C, FIG. 12C, FIG. 13C, FIG. 14C, FIG. 15C, and FIG. 16C respectively show distortion aberrations (DT) at the wide angle end. FIG. 9D, FIG. 10D, FIG. 11D, FIG. 12D, FIG. 13D, FIG. 14D, FIG. 15D, and FIG. 16D respectively show magnification chromatic aberrations (CC) at the wide angle end.

FIG. 9E, FIG. 10E, FIG. 11E, FIG. 12E, FIG. 13E, FIG. 14E, FIG. 15E, and FIG. 16E respectively show spherical aberrations (SA) in an intermediate focal length state. FIG. 9F, FIG. 10F, FIG. 11F, FIG. 12F, FIG. 13F, FIG. 14F, FIG. 15F, and FIG. 16F respectively show astigmatisms (AS) in the intermediate focal length state. FIG. 9G, FIG. 10G, FIG. 11G, FIG. 12G, FIG. 13G, FIG. 14G, FIG. 15G, and FIG. 16G respectively show distortion aberrations (DT) in the intermediate focal length state. FIG. 9H, FIG. 10H, FIG. 11H, FIG. 12H, FIG. 13H, FIG. 14H, FIG. 15H, and FIG. 16H respectively show magnification chromatic aberrations (CC) in the intermediate focal length state.

FIG. 9I, FIG. 10I, FIG. 11I, FIG. 12I, FIG. 13I, FIG. 14I, FIG. 15I, and FIG. 16I respectively show spherical aberrations (SA) at the telephoto end. FIG. 9J, FIG. 10J, FIG. 11J, FIG. 12J, FIG. 13J, FIG. 14J, FIG. 15J, and FIG. 16J respectively show astigmatisms (AS) at the telephoto end. FIG. 9K, FIG. 10K, FIG. 11K, FIG. 12K, FIG. 13K, FIG. 14K, FIG. 15K, and FIG. 16K respectively show distortion aberrations (DT) at the telephoto end. FIG. 9L, FIG. 10L, FIG. 11L, FIG. 12L, FIG. 13L, FIG. 14L, FIG. 15L, and FIG. 16L respectively show magnification chromatic aberrations (CC) at the telephoto end.

In the respective aberration diagrams, a horizontal axis indicates an aberration amount. A unit of aberration amounts of the spherical aberration, the astigmatism, and the magnification chromatic aberration is mm. A unit of an aberration amount of the distortion aberration is %. An aberration curve indicates a g line (having a wavelength of 435.8 nm) with an alternate long and short dash line, indicates a C line (having a wavelength of 656.3 nm) with a dotted line, and indicates a d line (having a wavelength of 587.6 nm) with a solid line. Note that a unit of the wavelengths is nm. In the respective figures, “FNO.” indicates an F number and “FIY” indicates a half angle of view.

Note that the respective sectional views show dispositions of the respective lens groups at the time when the zoom lenses in the respective examples are in a focused state on an infinity object. The respective aberration diagrams show various aberrations that occur when the zoom lenses in the respective examples are in a focused state on the infinity object.

In the zoom lenses in the respective examples, a reference sign G1 indicates the first lens group, a reference sign G1 indicates the second lens group, a reference sign G3 indicates the third lens group, a reference sign G4 indicates the fourth lens group, a reference sign G5 indicates the rear side lens group (hereinafter referred to as fifth lens group), a reference sign S indicates an aperture stop, and a reference sign I indicates an image surface. A cover glass C is disposed between the fifth lens group G5 and the image surface I.

Note that, in the respective sectional views, all surface numbers in the respective optical systems are not given in order to avoid complication of the drawings, Only surface numbers of lens surfaces on the most object side in the respective lens groups are given. Description of the other surface numbers is omitted.

In the respective sectional views, a reference sign d indicates an interval between lens surfaces. A reference sign is given to and shown in only a part (a variable part) where a surface interval changes when a predetermined lens group moves in an optical axis direction in order to avoid complication of the drawings.

Although not shown in the respective sectional views, a parallel flat plate configuring a low-pass filter may be disposed between the fifth lens group G5 and the image surface I. In this case, wavelength region limitation coating for limiting transmission of infrared light may be applied to a surface of the parallel flat plate. Multilayer film coating for wavelength region limitation for limiting transmission of light in a predetermined wavelength region may be applied to a surface of the cover glass C. Further, low-pass filter action may be imparted to the cover glass C.

The zoom lens in the example 1 includes, in order from the object side, the first lens group G1 having the positive focal length, the second lens group G2 having the negative focal length, the third lens group G3 including the aperture stop S and having the positive focal length, the fourth lens group G4 having the negative focal length, and the fifth lens group G5, which is the rear side lens group. Note that the aperture stop S is present further on the image side than the second lens group G2 and disposed on the most object side of the third lens group G3.

The first lens group G1 includes a negative meniscus lens L1, a convex surface of which is directed to the object side, a biconvex positive lens L2, and a positive meniscus lens L3, a convex surface of which is directed to the object side. The negative meniscus lens L1 and the biconvex positive lens L2 are bonded.

The second lens group G2 includes a positive meniscus lens L4, a convex surface of which is directed to the image side, a biconcave negative lens L5, a positive meniscus lens L6, a convex surface of which is directed to the object side, and a negative meniscus lens L7, a convex surface of which is directed to the image side. The positive meniscus lens L4, the biconcave negative lens L5, and the positive meniscus lens L6 are bonded.

The third lens group G3 includes a biconvex positive lens L8, a biconvex positive lens L9, a negative meniscus lens L10, a convex surface of which is directed to the object side, and a biconvex positive lens L11. The negative meniscus lens L10 and the biconvex positive lens L11 are bonded.

The fourth lens group G4 includes a positive meniscus lens L12, a convex surface of which is directed to the object side, and a negative meniscus lens L13, a convex surface of which is directed to the object side. The positive meniscus lens L12 and the negative meniscus lens L13 are bonded.

The fifth lens group G5 includes a biconcave negative lens L14 and a biconvex positive lens L15. The biconcave negative lens L14 and the biconvex positive lens 15 are bonded.

At a power varying operation time (a zooming time) from the wide angle end to the telephoto end, the first lens group G1, the third lens group G3 including the aperture stop S, and the fifth lens group G5 are fixed. The second lens group G2 moves from the object side to the image side. The fourth lens group G4 moves to the image side and, thereafter, moves to the object side.

Aspherical surfaces are provided on three surfaces in total, that is, both surfaces of the biconvex positive lens L8 and an image side surface of the negative meniscus lens L13.

The zoom lens in the example 2 includes, in order from the object side, the first lens group G1 having the positive focal length, the second lens group G2 having the negative focal length, the third lens group G3 including the aperture stop S and having the positive focal length, the fourth lens group G4 having the negative focal length, and the fifth lens group G5 , which is the rear side lens group. Note that the aperture stop S is present further on the image side than the second lens group G2 and is disposed on the most object side of the third lens group G3.

The first lens group G1 includes the negative meniscus lens L1, the convex surface of which is directed to the object side, the biconvex positive lens L2, and the positive meniscus lens L3, the convex surface of which is directed to the object side. The negative meniscus lens L1 and the biconvex positive lens L2 are bonded.

The second lens group G2 includes the positive meniscus lens L4, the convex surface of which is directed to the image side, the biconcave negative lens L5, the positive meniscus lens L6, the convex surface of which is directed to the object side, and the negative meniscus lens L7, the convex surface of which is directed to the image side. The positive meniscus lens L4, the biconcave negative lens L5, and the positive meniscus lens L6 are bonded.

The third lens group G3 includes the biconvex positive lens L8, the biconvex positive lens L9, the negative meniscus lens L10, the convex surface of which is directed to the object side, and the biconvex positive lens L11. The negative meniscus lens L10 and the biconvex positive lens L11 are bonded.

The fourth lens group G4 includes the positive meniscus lens L12, the convex surface of which is directed to the object side, and the negative meniscus lens L13, the convex surface of which is directed to the object side. The positive meniscus lens L12 and the negative meniscus lens L13 are bonded.

The fifth lens group G5 includes the biconcave negative lens L14 and the biconvex positive lens L15. The biconcave negative lens L14 and the biconvex positive lens L15 are bonded.

At the power varying operation time (the zooming time) from the wide angle end to the telephoto end, the first lens group G1, the third lens group G3 including the aperture stop S, and the fifth lens group G5 are fixed. The second lens group G2 moves from the object side to the image side. The fourth lens group G4 moves to the image side and, thereafter, moves to the object side.

Aspherical surfaces are provided on three surfaces in total, that is, both the surfaces of the biconvex positive lens L8 and the image side surface of the negative meniscus lens L13.

The zoom lens in the example 3 includes, in order from the object side, the first lens group G1 having the positive focal length, the second lens group G2 having the negative focal length, the third lens group G3 including the aperture stop S and having the positive focal length, the fourth lens group G4 having the negative focal length, and the fifth lens group G5, which is the rear side lens group. Note that the aperture stop S is present further on the image side than the second lens group G2 and is disposed on the most object side of the third lens group G3.

The first lens group G1 includes the negative meniscus lens L1, the convex surface of which is directed to the object side, the biconvex positive lens L2, and the positive meniscus lens L3, the convex surface of which is directed to the object side. The negative meniscus lens L1 and the biconvex positive lens L2 are bonded.

The second lens group G2 includes the positive meniscus lens L4, the convex surface of which is directed to the image side, the biconcave negative lens L5, the positive meniscus lens L6, the convex surface of which is directed to the object side, and the negative meniscus lens L7, the convex surface of which is directed to the image side. The positive meniscus lens L4, the biconcave negative lens L5, and the positive meniscus lens L6 are bonded.

The third lens group G3 includes the biconvex positive lens L8, the biconvex positive lens L9, the negative meniscus lens L10, the convex surface of which is directed to the object side, a positive meniscus lens L11, a convex surface of which is directed to the object side, and a biconvex positive lens L12. The negative meniscus lens L10 and the positive meniscus lens L11 are bonded.

The fourth lens group G4 includes the negative meniscus lens L13, the convex surface of which is directed to the object side, and a positive meniscus lens L14, a convex surface of which is directed to the object side. The negative meniscus lens L13 and the positive meniscus lens L14 are bonded.

The fifth lens group G5 includes a positive meniscus lens L15, a convex surface of which is directed to the object side.

At the power varying operation time (the zooming time) from the wide angle end to the telephoto end, the first lens group G1, the third lens group G3 including the aperture stop S, and the fifth lens group G5 are fixed, The second lens group G2 moves from the object side to the image side. The fourth lens group G4 moves to the image side and, thereafter, moves to the object side.

Aspherical surfaces are provided on three surfaces in total, that is, both the surfaces of the biconvex positive lens L8 and the object side surface of the negative meniscus lens L13.

The zoom lens in the example 4 includes, in order from the object side, the first lens group G1 having the positive focal length, the second lens group G2 having the negative focal length, the third lens group G3 including the aperture stop S and having the positive focal length, the fourth lens group G4 having the negative focal length, and the fifth lens group G5, which is the rear side lens group. Note that the aperture stop S is present further on the image side than the second lens group G2 and is disposed on the most object side of the third lens group G3.

The first lens group G1 includes the negative meniscus lens L1, the convex surface of which is directed to the object side, the biconvex positive lens L2, and the positive meniscus lens L3, the convex surface of which is directed to the object side. The negative meniscus lens L1 and the biconvex positive lens L2 are bonded.

The second lens group G2 includes the positive meniscus lens L4, the convex surface of which is directed to the image side, the biconcave negative lens L5, the positive meniscus lens L6, the convex surface of Which is directed to the object side, and the negative meniscus lens L7, the convex surface of which is directed to the image side. The positive meniscus lens L4, the biconcave negative lens L5, and the positive meniscus lens L6 are bonded.

The third lens group G3 includes the biconvex positive lens L8, the biconvex positive lens L9, the negative meniscus lens L10, the convex surface of which is directed to the object side, the biconvex positive lens L11, and the biconvex positive lens L12. The negative meniscus lens L10 and the biconvex positive lens L11 are bonded.

The fourth lens group G4 includes a biconvex positive lens L13 and the biconcave negative lens L14. The biconvex positive lens L13 and the biconcave negative lens L14 are bonded.

The fifth lens group G5 includes the positive meniscus lens L15, the convex surface of which is directed to the object side.

At the power varying operation time (the zooming time) from the wide angle end to the telephoto end, the first lens group G1, the third lens group G3 including the aperture stop S, and the fifth lens group G5 are fixed. The second lens group G2 moves from the object side to the image side. The fourth lens group G4 moves to the image side and, thereafter, moves to the object side.

Aspherical surfaces are provided on three surfaces in total, that is, both the surfaces of the biconvex positive lens L8 and an image side surface of a negative meniscus lens L14.

The zoom lens in the example 5 includes, in order from the object side, the first lens group G1 having the positive focal length, the second lens group G2 having the negative focal length, the third lens group G3 including the aperture stop S and having the positive focal length, the fourth lens group G4 having the negative focal length, and the fifth lens group G5, which is the rear side lens group. Note that the aperture stop S is present further on the image side than the second lens group G2 and is disposed on the most object side of the third lens group G3.

The first lens group G1 includes the negative meniscus lens L1, the convex surface of which is directed to the object side, the biconvex positive lens L2, and the positive meniscus lens L3, the convex surface of which is directed to the object side. The negative meniscus lens L1 and the biconvex positive lens L2 are bonded.

The second lens group G2 includes the positive meniscus lens L4, the convex surface of which is directed to the image side, the biconcave negative lens L5, the positive meniscus lens L6, the convex surface of which is directed to the object side, and a biconcave negative lens L7. The positive meniscus lens L4, the biconcave negative lens L5, and the positive meniscus lens L6 are bonded.

The third lens group G3 includes the biconvex positive lens L8, a negative meniscus lens L9, a convex surface of which is directed to the object side, a biconvex positive lens L10, and the biconvex positive lens L11. The negative meniscus lens L9 and the biconvex positive lens L10 are bonded.

The fourth lens group G4 includes the biconvex positive lens L12 and a biconcave negative lens L13, The biconvex positive lens L12 and the biconcave negative lens L13 are bonded.

The fifth lens group G5 includes the positive meniscus lens L14, the convex surface of which is directed to the image side.

At the power varying operation time (the zooming time) from the wide angle end to the telephoto end, the first lens group G1, the third lens group G3 including the aperture stop S, and the fifth lens group G5 are fixed, The second lens group G2 moves from the object side to the image side. The fourth lens group G4 moves to the image side and, thereafter, moves to the object side.

Aspherical surfaces are provided on five surfaces in total, that is, both the surfaces of the biconvex positive lens L8, an image side surface of the biconcave negative lens L13, and both surfaces of the positive meniscus lens L14.

The zoom lens in the example 6 includes, in order from the object side, the first lens group G1 having the positive focal length, the second lens group G2 having the negative focal length, the third lens group G3 including the aperture stop S and having the positive focal length, the fourth lens group G4 having the negative focal length, and the fifth lens group G5, which is the rear side lens group. Note that the aperture stop S is present further on the image side than the second lens group G2 and is disposed on the most object side of the third lens group G3.

The first lens group G1 includes the negative meniscus lens L1, the convex surface of which is directed to the object side, the biconvex positive lens L2, and the positive meniscus lens L3, the convex surface of which is directed to the object side. The negative meniscus lens L1 and the biconvex positive lens L2 are bonded.

The second lens group G2 includes the positive meniscus lens L4, the convex surface of which is directed to the image side, the biconcave negative lens L5, the positive meniscus lens L6, the convex surface of which is directed to the object side, and the negative meniscus lens L7, the convex surface of which is directed to the image side. The positive meniscus lens L4, the biconcave negative lens L5, and the positive meniscus lens L6 are bonded.

The third lens group G3 includes the biconvex positive lens L8, the negative meniscus lens L9, the convex surface of which is directed to the object side, the biconvex positive lens L10, and the positive meniscus lens L11, the convex surface of which is directed to the image side. The negative meniscus lens L9 and the biconvex positive lens L10 are bonded.

The fourth lens group G4 includes the biconvex positive lens L12 and the biconcave negative lens L13. The biconvex positive lens L12 and the biconcave negative lens L13 are bonded.

The fifth lens group G5 includes the biconcave negative lens L14 and the biconvex positive lens L15.

At the power varying operation time (the zooming time) from the wide angle end to the telephoto end, the first lens group G1, the third lens group G3 including the aperture stop S, and the fifth lens group G5 are fixed. The second lens group G2 moves from the object side to the image side. The fourth lens group G4 moves to the image side and, thereafter, moves to the object side.

Aspherical surfaces are provided on three surfaces in total, that is, both the surfaces of the biconvex positive lens L8 and the image side surface of the biconcave negative lens L13.

The zoom lens in the example 7 includes, in order from the object side, the first lens group G1 having the positive focal length, the second lens group G2 having the negative focal length, the third lens group G3 including the aperture stop S and having the positive focal length, the fourth lens group G4 having the negative focal length, and the fifth lens group G5, which is the rear side lens group. Note that the aperture stop S is present further on the image side than the second lens group G2 and is disposed on the most object side of the third lens group G3.

The first lens group G1 includes the negative meniscus lens L1, the convex surface of which is directed to the object side, a positive meniscus lens L2, a convex surface of which is directed to the object side, and a planoconvex positive lens L3, a convex surface of which is directed to the object side. The negative meniscus lens L1 and the positive meniscus lens L2 are bonded.

The second lens group G2 includes the positive meniscus lens L4, the convex surface of which is directed to the image side, the biconcave negative lens L5, the positive meniscus lens L6, the convex surface of Which is directed to the object side, and the negative meniscus lens L7, the convex surface of which is directed to the image side. The positive meniscus lens L4, the biconcave negative lens L5, and the positive meniscus lens L6 are bonded.

The third lens group G3 includes a positive meniscus lens L8, a convex surface of which is directed to the object side, the biconvex positive lens L9, the negative meniscus lens L10, the convex surface of which is directed to the object side, and the biconvex positive lens L11. The negative meniscus lens L10 and the biconvex positive lens L11 are bonded.

The fourth lens group G4 includes the biconvex positive lens L12 and the biconcave negative lens L13. The biconvex positive lens L12 and the biconcave negative lens L13 are bonded.

The fifth lens group G5 includes the biconcave negative lens L14 and the biconvex positive lens L15.

At the power varying operation time (the zooming time) from the wide angle end to the telephoto end, the first lens group G1, the third lens group G3 including the aperture stop S, and the fifth lens group G5 are fixed. The second lens group G2 moves from the object side to the image side. The fourth lens group G4 moves to the image side and, thereafter, moves to the object side.

Aspherical surfaces are provided on three surfaces in total, that is, both the surfaces of the biconvex positive lens L8 and the image side surface of the biconcave negative lens L13.

The zoom lens in the example 8 includes, in order from the object side, the first lens group G1 having the positive focal length, the second lens group G2 having the negative focal length, the third lens group G3 including the aperture stop S and having the positive focal length, the fourth lens group G4 having the negative focal length, the fifth lens group G5, which is the rear side lens group, and a sixth lens group G6. Note that the aperture stop S is present further on the image side than the second lens group G2 and is disposed on the most object side of the third lens group G3.

The first lens group G1 includes the negative meniscus lens L1, the convex surface of which is directed to the object side, the biconvex positive lens L2, and the planoconvex positive lens L3, the convex surface of which is directed to the object side. The negative meniscus lens L1 and the biconvex positive lens L2 are bonded.

The second lens group G2 includes the positive meniscus lens L4, the convex surface of which is directed to the image side, the biconcave negative lens L5, the positive meniscus lens L6, the convex surface of which is directed to the object side, and the biconcave negative lens L7. The positive meniscus lens L4, the biconcave negative lens L5, and the positive meniscus lens L6 are bonded.

The third lens group G3 includes the biconvex positive lens L8, the biconvex positive lens L9, the negative meniscus lens L10, the convex surface of which is directed to the object side, and the biconvex positive lens L11. The negative meniscus lens L10 and the biconvex positive lens L11 are bonded.

The fourth lens group G4 includes the biconvex positive lens L12 and the biconcave negative lens L13. The biconvex positive lens L12 and the biconcave negative lens L13 are bonded.

The fifth lens group G5 includes the negative meniscus lens L14, the convex surface of which is directed to the image side. The sixth lens group G6 includes the positive meniscus lens L15, the convex surface of which is directed to the image side.

At the power varying operation time (the zooming time) from the wide angle end to the telephoto end, the first lens group G1, the third lens group G3 including the aperture stop S, and the sixth lens group G6 are fixed. The second lens group G2 moves from the object side to the image side. The fourth lens group G4 moves to the image side and, thereafter, moves to the object side. The fifth lens group moves to the object side and, thereafter, moves to the image side.

Aspherical surfaces are provided on three surfaces in total, that is, both the surfaces of the biconvex positive lens L8 and the image side surface of the biconcave negative lens L13.

Numerical value data in the respective examples are shown below. in surface data, a sign r indicates a curvature radius (mm) of respective lens surfaces, a sign d indicates an interval (mm) among the respective lens surfaces, a sign nd indicates a refractive index on a d line of the respective lenses, and a sign vd indicates an Abbe number on the d line of the respective lenses. Note that, in a section of a surface number, “*” indicates an aspherical surface.

In zoom data, “wide angle” indicates the wide angle end, “intermediate” indicates the intermediate focal length state between the wide angle end and the telephoto end, and “telephoto” indicates the telephoto end, When zooming is performed from the wide angle end to the telephoto end, the zooming is performed in the order of the wide angle end, the intermediate focal length state, and the telephoto end.

In the zoom data, “focal length” indicates a focal length of the entire zoom lens, a sign FNO. indicates an F number, a sign 2ω indicates an angle of view, a sign BF indicates a back focus, “total length” indicates a total length of the optical system, Note that the back focus BF aerially converts and indicates a distance from a lens surface on the most image side to a paraxial image surface. The total length of the optical system indicates a distance obtained by adding the back focus BF to a distance from a lens surface on the most object side to the lens surface on the most image side.

In respective group focal lengths, f1, f2, f3, f4, and f5 indicate focal lengths of the respective lens groups.

An aspherical surface shape is represented by a following expression when a direction along an optical axis is represented as Z and a direction orthogonal to the optical axis is represented as Y.

z=(y²/r)/[1+{1−(1+k)(y/r)²}^{1/2}]+A4y⁴+A6y⁶+A8y⁸+A10y¹⁰+ . . .

where a sign z indicates a sag amount of an aspherical surface in a direction (a Z direction) along the optical axis, a sign y indicates a height dimension in a direction (a Y direction) orthogonal to the optical axis, and a sign k indicates a conic coefficient.

In aspherical surface data, signs A4, A6, A8, A10, and the like respectively indicate aspherical surface coefficients. Note that in the aspherical surface coefficients, notation “e-n” (n is an integer) indicates “10⁻ⁿ”. The signs about these specification values are common in numerical value data in examples explained below.

### NUMERICAL VALUE EXAMPLE 1

Unit mm
Surface data

| Surface number | r | d | nd | vd |
|---|---|---|---|---|
| 1 | 70.041 | 2.00 | 1.80000 | 29.84 |
| 2 | 46.975 | 6.90 | 1.49700 | 81.54 |
| 3 | −315.584 | 0.15 | | |
| 4 | 83.054 | 3.00 | 1.43875 | 94.66 |
| 5 | 274.320 | variable | | |
| 6 | −347.954 | 3.30 | 1.80810 | 22.76 |
| 7 | −44.207 | 1.40 | 1.48749 | 70.23 |
| 8 | 22.630 | 2.10 | 1.80000 | 29.84 |
| 9 | 26.046 | 5.53 | | |
| 10 | −30.946 | 1.00 | 1.85150 | 40.78 |
| 11 | −1250.140 | variable | | |
| 12 (aperture) | ∞ | 1.00 | | |
| 13* | 34.063 | 3.30 | 1.58313 | 59.38 |
| 14* | −1201.005 | 6.59 | | |
| 15 | 28.050 | 4.60 | 1.48749 | 70.23 |
| 16 | −47.935 | 0.15 | | |
| 17 | 45.152 | 1.00 | 1.91082 | 35.25 |
| 18 | 15.131 | 5.50 | 1.49700 | 81.54 |
| 19 | −45.996 | variable | | |
| 20 | 43.494 | 1.70 | 1.92286 | 20.88 |
| 21 | 121.614 | 1.10 | 1.80610 | 40.92 |
| 22* | 15.400 | variable | | |
| 23 | −17.949 | 1.20 | 1.51823 | 58.90 |
| 24 | 33.945 | 6.60 | 1.59270 | 35.31 |
| 25 | −22.333 | 11.83 | | |
| 26 | ∞ | 4.00 | 1.51633 | 64.10 |
| 27 | ∞ | 0.80 | | |
| Image surface | ∞ | | | |

Aspherical surface data

Thirteenth surface
k = 0.000
A4 = −8.93208e−06, A6 = −2.37994e−08, A8 = −4.33328e−10
Fourteenth surface
k = 0.000
A4 = 1.38499e−05, A6 = −1.63147e−08, A8 = −4.08002e−10
Twenty-second surface
k = −1.383
A4 = 4.67270e−05, A6 = 1.02479e−07, A8 = −3.43262e−10

Zoom data

| | Wide angle | Intermediate | Telephoto |
|---|---|---|---|
| Focal length | 40.71 | 77.42 | 146.90 |
| FNO. | 4.07 | 4.08 | 4.08 |
| Angle of view 2ω | 30.04 | 15.54 | 8.18 |
| d5 | 5.64 | 25.36 | 41.77 |
| d11 | 39.53 | 19.81 | 3.40 |
| d19 | 3.05 | 5.81 | 5.03 |
| d22 | 20.87 | 18.21 | 18.99 |
| BF | 15.25 | 15.27 | 15.25 |
| Total length | 142.46 | 142.58 | 142.56 |

Respective group focal lengths
f1 = 98.45 f2 = −25.54 f3 = −23.98 f4 = −32.85
f5 = 290.25

### NUMERICAL VALUE EXAMPLE 2

Unit mm
Surface data

| Surface number | r | d | nd | vd |
|---|---|---|---|---|
| 1 | 68.995 | 2.00 | 1.80000 | 29.84 |
| 2 | 46.430 | 6.90 | 1.49700 | 81.54 |
| 3 | −336.918 | 0.15 | | |
| 4 | 84.102 | 3.00 | 1.43875 | 94.66 |
| 5 | 286.533 | variable | | |
| 6 | −446.859 | 3.30 | 1.80810 | 22.76 |
| 7 | −43.564 | 1.40 | 1.48749 | 70.23 |
| 8 | 22.908 | 2.10 | 1.80000 | 29.84 |
| 9 | 25.932 | 5.10 | | |
| 10 | −30.383 | 1.00 | 1.85150 | 40.78 |
| 11 | −5804.316 | variable | | |
| 12 (aperture) | ∞ | 1.00 | | |
| 13* | 34.143 | 3.30 | 1.58313 | 59.38 |
| 14* | −9333.798 | 6.27 | | |
| 15 | 27.209 | 4.60 | 1.48749 | 70.23 |
| 16 | −46.118 | 0.15 | | |
| 17 | 44.157 | 1.00 | 1.91082 | 35.25 |
| 18 | 14.827 | 5.50 | 1.49700 | 81.54 |
| 19 | −45.178 | variable | | |
| 20 | 41.490 | 1.70 | 1.92286 | 20.88 |
| 21 | 125.885 | 1.10 | 1.80610 | 40.92 |
| 22* | 14.885 | variable | | |
| 23 | −17.327 | 1.20 | 1.51633 | 64.14 |
| 24 | 73.286 | 6.40 | 1.59270 | 35.31 |
| 25 | −20.485 | 11.82 | | |
| 26 | ∞ | 4.00 | 1.51633 | 64.10 |
| 27 | ∞ | 0.80 | | |
| Image surface | ∞ | | | |

Aspherical surface data

Thirteenth surface
k = 0.000
A4 = −1.07375e−05, A6 = −3.33866e−08, A8 = −4.79463e−10
Fourteenth surface
k−0.000
A4 = 1.35017e−05, A6 = −2.56501e−08, A8 = −4.30753e−10
Twenty-second surface
k = −1.386
A4 = 5.30403e−05, A6 = 6.44974e−08, A8 = 3.99085e−10

Zoom data

| | Wide angle | Intermediate | Telephoto |
|---|---|---|---|
| Focal length | 40.76 | 77.41 | 146.89 |
| FNO. | 4.07 | 4.08 | 4.08 |
| Angle of view 2ω | 29.96 | 15.52 | 8.16 |
| d5 | 6.60 | 26.09 | 42.30 |
| d11 | 39.10 | 19.62 | 3.40 |
| d19 | 3.02 | 5.78 | 5.05 |
| d22 | 20.91 | 18.15 | 18.89 |
| BF | 15.23 | 15.25 | 15.24 |
| Total length | 142.05 | 142.06 | 142.05 |

Respective group focal lengths
f1 = 98.44 f2 = −25.22 f3 = 23.63 f4 = −32.20 f5 = 236.72

### NUMERICAL VALUE EXAMPLE 3

Unit mm
Surface data

| Surface number | r | d | nd | vd |
|---|---|---|---|---|
| 1 | 112.443 | 2.00 | 1.80000 | 29.84 |
| 2 | 61.170 | 6.30 | 1.49700 | 81.54 |
| 3 | −151.780 | 0.15 | | |
| 4 | 56.194 | 3.70 | 1.43875 | 94.66 |
| 5 | 182.314 | variable | | |
| 6 | −160.096 | 2.80 | 1.80810 | 22.76 |
| 7 | −47.292 | 1.40 | 1.48749 | 70.23 |
| 8 | 18.747 | 2.30 | 1.78880 | 28.43 |
| 9 | 24.087 | 8.05 | | |
| 10 | −33.168 | 1.00 | 1.85150 | 40.78 |
| 11 | −432.238 | variable | | |
| 12 (aperture) | ∞ | 1.40 | | |
| 13* | 24.228 | 4.10 | 1.58313 | 59.38 |
| 14* | −393.030 | 0.50 | | |
| 15 | 40.020 | 2.80 | 1.48749 | 70.23 |
| 16 | −1155.397 | 0.15 | | |
| 17 | 38.213 | 1.00 | 1.90366 | 31.32 |
| 18 | 14.528 | 3.70 | 1.49700 | 81.54 |
| 19 | 33.599 | 6.89 | | |
| 20 | 46.660 | 3.50 | 1.51633 | 64.14 |
| 21 | −33.733 | variable | | |
| 22* | 70.103 | 1.10 | 1.74320 | 49.34 |
| 23 | 12.129 | 2.00 | 1.92286 | 20.88 |
| 24 | 14.692 | variable | | |
| 25 | 22.254 | 3.00 | 1.48749 | 70.23 |
| 26 | 39.154 | 19.83 | | |
| 27 | ∞ | 4.00 | 1.51633 | 64.10 |
| 28 | ∞ | 0.80 | | |
| Image surface | ∞ | | | |

Aspherical surface data

Thirteenth surface
k = 0.000
A4 = −6.25413e−06, A6 = 1.92611e−08, A8 = 1.20552e−11
Fourteenth surface
k = 0.000
A4 = 1.30311e−05, A6 = 2.19261e−08
Twenty-second surface
k = 0.000
A4 = 2.57603e−06, A6 = 2.41298e−08, A8 = 7.83280e−11

Zoom data

| | Wide angle | Intermediate | Telephoto |
|---|---|---|---|
| Focal length | 40.80 | 77.47 | 146.98 |
| FNO. | 4.08 | 4.08 | 4.08 |
| Angle of view 2ω | 30.22 | 15.60 | 8.22 |
| d5 | 3.47 | 22.41 | 38.34 |
| d11 | 36.88 | 17.94 | 2.00 |
| d21 | 4.39 | 7.58 | 6.28 |
| d24 | 16.27 | 13.08 | 14.38 |
| BF | 23.27 | 23.26 | 23.25 |
| Total length | 142.11 | 142.11 | 142.09 |

Respective group focal lengths
f1 = 92.56 f2 = −24.87 f3 = 26.69 f4 = −28.23 f5 = 99.95

### NUMERICAL VALUE EXAMPLE 4

Unit mm
Surface data

| Surface number | r | d | nd | vd |
|---|---|---|---|---|
| 1 | 96.654 | 2.00 | 1.80000 | 29.84 |
| 2 | 57.150 | 6.65 | 1.49700 | 81.54 |
| 3 | −166.039 | 0.15 | | |
| 4 | 61.504 | 3.50 | 1.43875 | 94.66 |
| 5 | 175.467 | variable | | |
| 6 | −197.690 | 2.90 | 1.80810 | 22.76 |
| 7 | −42.491 | 1.40 | 1.48749 | 70.23 |
| 8 | 20.889 | 2.00 | 1.78880 | 28.43 |
| 9 | 25.535 | 5.02 | | |
| 10 | −32.486 | 1.00 | 1.85150 | 40.78 |
| 11 | −1881.450 | variable | | |
| 12 (aperture) | ∞ | 1.00 | | |
| 13* | 29.818 | 3.90 | 1.58313 | 59.38 |
| 14* | −168.092 | 3.37 | | |
| 15 | 66.894 | 2.50 | 1.48749 | 70.23 |
| 16 | −155.372 | 0.15 | | |
| 17 | 82.860 | 1.00 | 1.90366 | 31.32 |
| 18 | 20.003 | 4.10 | 1.49700 | 81.54 |
| 19 | −165.395 | 7.27 | | |
| 20 | 80.340 | 3.00 | 1.59282 | 68.63 |
| 21 | −42.744 | variable | | |
| 22 | 69.168 | 1.90 | 1.92286 | 20.88 |
| 23 | −184.698 | 1.10 | 1.74320 | 49.34 |
| 24* | 15.512 | variable | | |
| 25 | 22.647 | 2.50 | 1.54814 | 45.79 |
| 26 | 29.143 | 19.59 | | |
| 27 | ∞ | 4.00 | 1.51633 | 64.10 |
| 28 | ∞ | 0.80 | | |
| Image surface | ∞ | | | |

Aspherical surface data

Thirteenth surface
k = 0.000
A4 = −6.48758e−06, A6 = 2.60574e−09, A8 = −8.95283e−12
Fourteenth surface
k = 0.000
A4 = 9.17859e−06, A6 = −1.41660e−09
Twenty-fourth surface
k = 0.000
A4 = −3.35886e−06, A6 = −2.58014e−08, A8 = −2.40561e−10

Zoom data

| | Wide angle | Intermediate | Telephoto |
|---|---|---|---|
| Focal length | 40.80 | 77.44 | 146.87 |
| FNO. | 4.08 | 4.08 | 4.08 |
| Angle of view 2ω | 29.96 | 15.50 | 8.16 |
| d5 | 4.52 | 24.08 | 40.37 |
| d11 | 37.86 | 18.29 | 2.00 |
| d21 | 3.25 | 6.49 | 5.39 |
| d24 | 16.97 | 13.74 | 14.83 |
| BF | 23.04 | 23.02 | 23.02 |
| Total length | 142.06 | 142.04 | 142.04 |

Respective group focal lengths
f1 = 94.77 f2 = −25.44 f3 = 26.77 f4 = −30.73 f5 = 163.12

### NUMERICAL VALUE EXAMPLE 5

Unit mm
Surface data

| Surface number | r | d | nd | vd |
|---|---|---|---|---|
| 1 | 94.948 | 2.00 | 1.77047 | 29.74 |
| 2 | 56.677 | 6.05 | 1.49700 | 81.61 |
| 3 | −175.526 | 0.15 | | |
| 4 | 64.693 | 3.42 | 1.43875 | 94.66 |
| 5 | 186.554 | variable | | |
| 6 | −191.109 | 2.12 | 1.80810 | 22.76 |
| 7 | −41.867 | 1.60 | 1.48749 | 70.23 |
| 8 | 23.244 | 1.48 | 1.80000 | 29.84 |
| 9 | 28.426 | 2.95 | | |
| 10 | −35.641 | 1.50 | 1.83481 | 42.72 |
| 11 | 360.413 | variable | | |
| 12 (aperture) | ∞ | 1.80 | | |
| 13* | 31.392 | 5.07 | 1.49650 | 81.53 |
| 14* | −67.174 | 3.52 | | |
| 15 | 404.572 | 1.10 | 1.84666 | 23.78 |
| 16 | 44.822 | 3.58 | 1.59282 | 68.63 |
| 17 | −51.680 | 0.15 | | |
| 18 | 1722.574 | 6.51 | 1.49700 | 81.54 |
| 19 | −29.524 | variable | | |
| 20 | 200.241 | 1.75 | 1.92286 | 18.90 |
| 21 | −107.294 | 1.00 | 1.74320 | 49.34 |
| 22* | 20.918 | variable | | |
| 23* | −109.096 | 3.81 | 1.74320 | 49.29 |
| 24* | −78.960 | 16.85 | | |
| 25 | ∞ | 4.00 | 1.51633 | 64.10 |
| 26 | ∞ | 0.80 | | |
| Image surface | ∞ | | | |

Aspherical surface data

Thirteenth surface
k = 0.000
A4 = −1.24904e−05, A6 = −1.33128e−09, A8 = −4.31640e−10
Fourteenth surface
k = 0.000
A4 = 1.77832e−05, A6 = −3.93057e−10, A8 = −3.94137e−10
Twenty-second surface
k = −0.357
A4 = 6.08713e−08, A6 = 4.14745e−08, A8 = −8.20627e−10, A10 = 8.55838e−12
Twenty-third surface
k = −1.001
A4 = −7.24982e−05, A6 = −1.51347e−07, A8 = −5.90661e−10
Twenty-fourth surface
k = −1.068
A4 = −6.81745e−05, A6 = −8.61172e−08, A8 = −1.10539e−10

Zoom data

| | Wide angle | Intermediate | Telephoto |
|---|---|---|---|
| Focal length | 40.67 | 77.55 | 147.65 |
| FNO. | 4.08 | 4.08 | 4.08 |
| Angle of view 2ω | 30.60 | 15.72 | 8.22 |
| d5 | 3.71 | 24.10 | 41.33 |
| d11 | 39.47 | 19.13 | 1.73 |
| d19 | 3.67 | 6.15 | 4.91 |
| d22 | 26.23 | 23.70 | 25.14 |
| BF | 20.31 | 20.30 | 20.28 |
| Total length | 142.96 | 142.96 | 142.96 |

Respective group focal lengths
f1 = 95.25 f2 = −26.91 f3 = 24.60 f4 = −34.51 f5 = 364.93

### NUMERICAL VALUE EXAMPLE 6

Unit mm
Surface data

| Surface number | r | d | nd | vd |
|---|---|---|---|---|
| 1 | 97.693 | 2.00 | 1.77047 | 29.74 |
| 2 | 57.408 | 6.99 | 1.49700 | 81.61 |
| 3 | −166.046 | 0.15 | | |
| 4 | 60.998 | 3.66 | 1.43875 | 94.66 |
| 5 | 173.930 | variable | | |
| 6 | −152.231 | 2.40 | 1.80810 | 22.76 |
| 7 | −43.392 | 1.40 | 1.48749 | 70.23 |
| 8 | 22.635 | 1.45 | 1.78880 | 28.43 |
| 9 | 27.866 | 4.95 | | |
| 10 | −36.047 | 1.20 | 1.83481 | 42.72 |
| 11 | −2675.482 | variable | | |
| 12 (aperture) | ∞ | 1.80 | | |
| 13* | 26.015 | 5.48 | 1.49700 | 81.61 |
| 14* | −48.863 | 2.94 | | |
| 15 | 127.861 | 1.10 | 1.91650 | 31.60 |
| 16 | 30.483 | 9.55 | 1.49700 | 81.54 |
| 17 | −23.638 | 0.20 | | |
| 18 | −65.461 | 1.89 | 1.59282 | 68.63 |
| 19 | −49.936 | variable | | |
| 20 | 72.298 | 1.75 | 1.80810 | 22.76 |
| 21 | −321.249 | 1.00 | 1.74320 | 49.29 |
| 22* | 18.695 | variable | | |
| 23 | −22.519 | 1.20 | 1.48749 | 70.23 |
| 24 | 159.963 | 2.55 | | |
| 25 | 34.053 | 3.79 | 1.72916 | 54.68 |
| 26 | −142.838 | 11.36 | | |
| 27 | ∞ | 4.00 | 1.51633 | 64.10 |
| 28 | ∞ | 0.80 | | |
| Image surface | ∞ | | | |

Aspherical surface data

Thirteenth surface
k = 0.000
A4 = −1.01975e−05 A6 = 1.25246e−08 A8 = −1.82139e−10
Fourteenth surface
k = 0.000
A4 = 2.85553e−05 A6 = 1.36215e−08 A8 = −1.28554e−10
Twenty-second surface
k = −0.289
A4 = 1.86700e−06 A6 = 2.74311e−08 A8 = −2.48026e−10 A10 = 2.96428e−12

Zoom data

| | Wide angle | Intermediate | Telephoto |
|---|---|---|---|
| Focal length | 40.62 | 77.43 | 147.38 |
| FNO. | 4.08 | 4.08 | 4.08 |
| Angle of view 2ω | 30.78 | 15.82 | 8.28 |
| d5 | 3.53 | 23.85 | 40.64 |
| d11 | 39.61 | 19.41 | 2.24 |
| d19 | 4.87 | 7.18 | 4.30 |
| d22 | 21.76 | 19.34 | 22.59 |
| BF | 14.82 | 14.81 | 14.80 |
| Total length | 142.05 | 142.05 | 142.02 |

Respective group focal lengths
f1 = 93.22 f2 = −27.27 f3 = 25.67 f4 = −36.12 f5 = 254.96

### NUMERICAL VALUE EXAMPLE 7

Unit mm
Surface data

| Surface number | r | d | nd | vd |
|---|---|---|---|---|
| 1 | 64.777 | 2.00 | 1.80000 | 29.84 |
| 2 | 43.412 | 6.10 | 1.49700 | 81.54 |
| 3 | 4413.275 | 0.15 | | |
| 4 | 75.924 | 3.60 | 1.43875 | 94.66 |
| 5 | ∞ | variable | | |
| 6 | −1059.701 | 2.90 | 1.85478 | 24.80 |
| 7 | −49.612 | 1.40 | 1.48749 | 70.23 |
| 8 | 18.924 | 2.10 | 1.64769 | 33.79 |
| 9 | 24.587 | 7.16 | | |
| 10 | −28.740 | 1.00 | 1.83481 | 42.74 |
| 11 | −601.939 | variable | | |
| 12 (aperture) | ∞ | 1.40 | | |
| 13* | 40.098 | 3.60 | 1.58313 | 59.38 |
| 14* | 33180.233 | 6.12 | | |
| 15 | 33.598 | 4.00 | 1.48749 | 70.23 |
| 16 | −40.233 | 0.15 | | |
| 17 | 55.217 | 1.00 | 1.91082 | 35.25 |
| 18 | 17.190 | 5.50 | 1.49700 | 81.54 |
| 19 | −41.416 | variable | | |
| 20 | 40.546 | 2.20 | 1.80000 | 29.84 |
| 21 | −67.070 | 1.10 | 1.80610 | 40.92 |
| 22* | 17.435 | variable | | |
| 23 | −28.082 | 1.10 | 1.48749 | 70.23 |
| 24 | 23.285 | 5.00 | 1.62004 | 36.26 |
| 25 | −59.913 | 17.36 | | |
| 26 | ∞ | 4.00 | 1.51633 | 64.10 |
| 27 | ∞ | 0.80 | | |
| Image surface | ∞ | | | |

Aspherical surface data

Thirteenth surface
k = 0.000
A4 = −2.61836e−05 A6 = −1.69086e−07 A8 = −3.28652e−10
Fourteenth surface
k = 0.000
A4 = −3.09016e−06 A6 = −1.68861e−07 A8 = −1.06327e−10
Twenty-second surface
k = 0.000
A4 = −2.07584e−06 A6 = 4.47149e−08 A8 = −4.49686e−10 A10 = −3.08108e−12

Zoom data

| | Wide angle | Intermediate | Telephoto |
|---|---|---|---|
| Focal length | 40.79 | 77.44 | 147.04 |
| FNO. | 4.06 | 4.08 | 4.07 |
| Angle of view 2ω | 30.51 | 16.02 | 8.43 |
| d5 | 2.50 | 21.37 | 37.20 |
| d11 | 38.35 | 19.48 | 3.65 |
| d19 | 3.31 | 6.09 | 3.73 |
| d22 | 19.50 | 16.73 | 19.08 |
| BF | 20.83 | 20.82 | 20.84 |
| Total length | 142.07 | 142.05 | 142.08 |

Respective group focal lengths
f1 = 91.54 f2 = −25.16 f3 = 25.33 f4 = −40.12
f5 = −1348.10

### NUMERICAL VALUE EXAMPLE 8

Unit mm
Surface data

| Surface number | r | d | nd | vd |
|---|---|---|---|---|
| 1 | 84.072 | 2.00 | 1.80000 | 29.84 |
| 2 | 52.375 | 6.00 | 1.49700 | 81.54 |
| 3 | −509.455 | 0.15 | | |
| 4 | 70.476 | 3.70 | 1.43875 | 94.66 |
| 5 | ∞ | variable | | |
| 6 | −220.628 | 3.00 | 1.85478 | 24.80 |
| 7 | −41.331 | 1.40 | 1.48749 | 70.23 |
| 8 | 22.309 | 2.10 | 1.80810 | 22.76 |
| 9 | 25.398 | 4.48 | | |
| 10 | −29.642 | 1.00 | 1.83481 | 42.74 |
| 11 | 1596.456 | variable | | |
| 12 (aperture) | ∞ | 1.00 | | |
| 13* | 42.247 | 3.30 | 1.58313 | 59.38 |
| 14* | −800.000 | 6.42 | | |
| 15 | 29.243 | 4.60 | 1.48749 | 70.23 |
| 16 | −46.756 | 0.15 | | |
| 17 | 42.343 | 1.00 | 1.91082 | 35.25 |
| 18 | 15.398 | 5.50 | 1.49700 | 81.54 |
| 19 | −38.536 | variable | | |
| 20 | 35.684 | 2.50 | 1.80000 | 29.84 |
| 21 | −41.951 | 1.10 | 1.80610 | 40.92 |
| 22 | 14.558 | variable | | |
| 23 | −16.950 | 1.20 | 1.48749 | 70.23 |
| 24 | −89.857 | variable | | |
| 25 | −159.663 | 5.00 | 1.59270 | 35.31 |
| 26 | −20.946 | 11.82 | | |
| 27 | ∞ | 4.00 | 1.51633 | 64.10 |
| 28 | ∞ | 0.80 | | |
| Image surface | ∞ | | | |

Aspherical surface data

Thirteenth surface
k = 0.000
A4 = −2.56397e−05 A6 = −7.50240e−08 A8 = −9.92669e−10
Fourteenth surface
k = 0.000
A4 = −1.75687e−06 A6 = −7.46278e−08 A8 = −7.67338e−10
Twenty-second surface
k = 0.000
A4 = −1.57401e−06 A6 = 9.63445e−09 A8 = −6.33975e−10 A10 = 2.40565e−12

Zoom data

| | Wide angle | Intermediate | Telephoto |
|---|---|---|---|
| Focal length | 40.78 | 77.43 | 146.94 |
| FNO. | 4.08 | 4.08 | 4.09 |
| Angle of view 2ω | 30.54 | 15.97 | 8.40 |
| d5 | 6.77 | 25.38 | 40.82 |
| d11 | 37.48 | 18.87 | 3.42 |
| d19 | 3.26 | 6.02 | 4.82 |
| d22 | 20.76 | 17.79 | 19.12 |
| d24 | 2.47 | 2.67 | 2.53 |
| BF | 15.25 | 15.26 | 15.26 |
| Total length | 141.57 | 141.58 | 141.58 |

Respective group focal lengths
f1 = 92.57 f2 = −24.23 f3 = 23.78 f4 = −32.66 f5 = −43.08 f6 = 40.14

Subsequently, values of the conditional expressions in the respective examples are listed below.

| | example 1 | example 2 | example 3 | example 4 |
|---|---|---|---|---|
| Conditional expression (1) | 2.4185 | 2.41496 | 2.26867 | 2.32268 |
| Conditional expression (2) | −0.93886 | −0.93699 | −1.07338 | −1.05243 |
| Conditional expression (3) | 59.38 | 59.38 | 59.38 | 59.38 |
| Conditional expression (4) | 81.54 | 81.54 | 64.14 | 68.63 |
| Conditional expression (5) | −4.06 | −4.11 | −3.61 | −3.65 |
| Conditional expression (6) | −1.17663 | −1.23399 | −1.17422 | −1.01478 |
| | example 5 | example 6 | example 7 | example 8 |
| Conditional expression (1) | 2.34227 | 2.29515 | 2.24453 | 2.27006 |
| Conditional expression (2) | −0.91409 | −0.94151 | −1.00706 | −0.98174 |
| Conditional expression (3) | 81.53 | 81.61 | 59.38 | 59.38 |
| Conditional expression (4) | 81.54 | 68.63 | 81.54 | 81.54 |
| Conditional expression (5) | −4.46 | −3.55 | −3.423 | −4.114 |
| Conditional expression (6) | −1.04296 | −1.31084 | −0.98420 | −1.52237 |

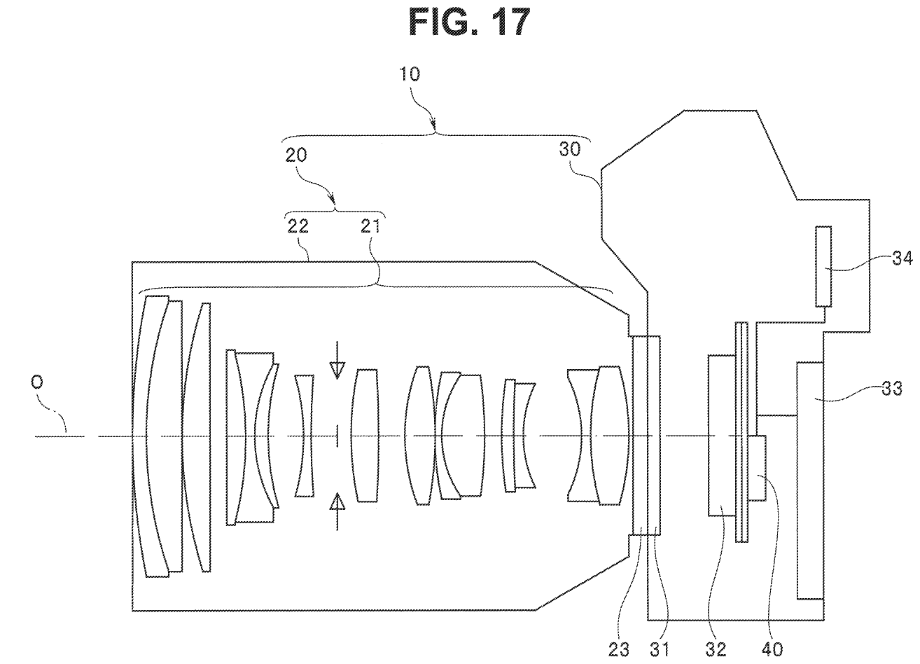

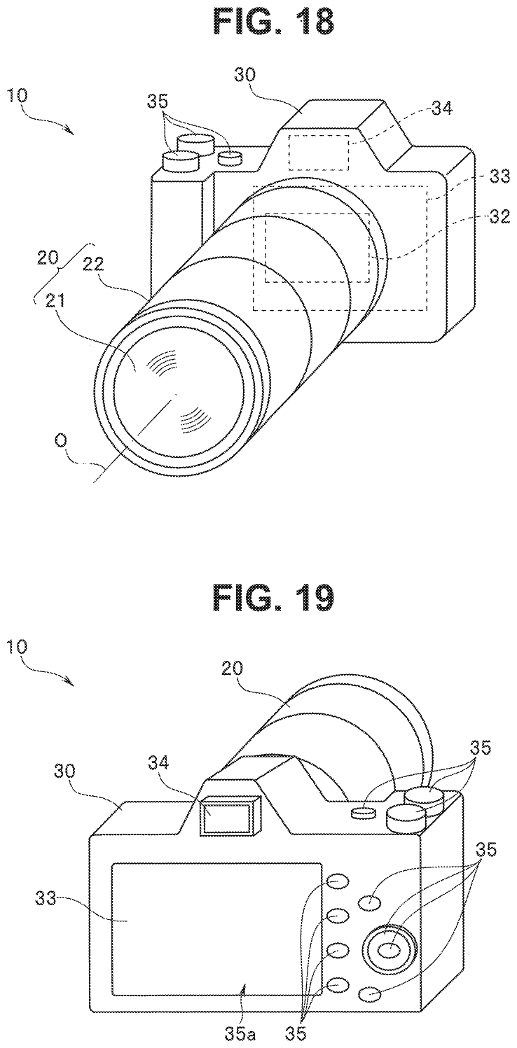

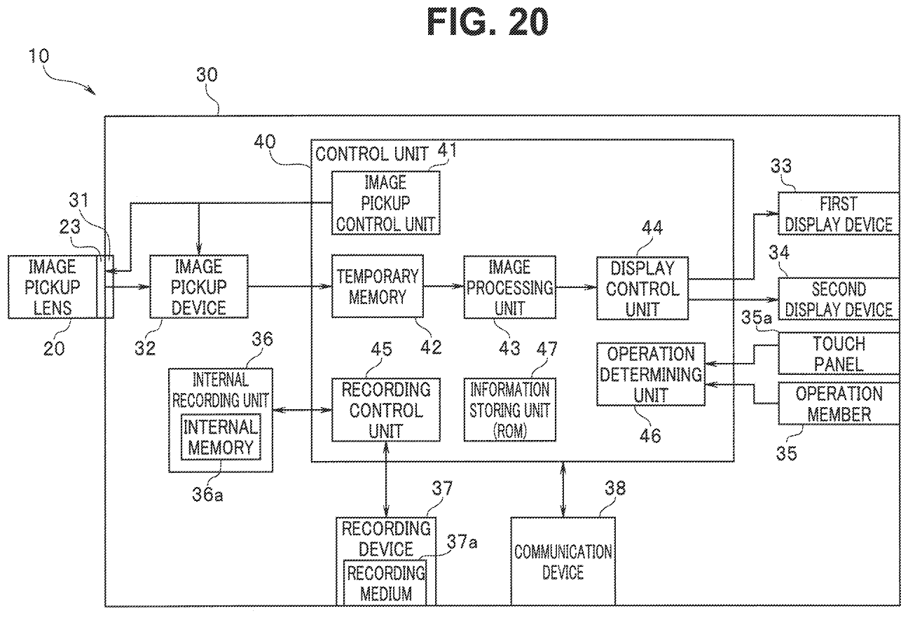

Subsequently, a schematic configuration of an image pickup apparatus in an embodiment of the present invention is briefly explained below with reference to FIGS. 17 to 20. FIGS. 17 to 20 are diagrams showing the schematic configuration of the image pickup apparatus in the embodiment of the present invention. FIG. 17 is a conceptual diagram showing the schematic configuration of the image pickup apparatus in the embodiment of the present invention. FIG. 18 is a schematic perspective view mainly showing a front surface side of the image pickup apparatus. FIG. 19 is a schematic perspective view mainly showing a rear surface side of the image pickup apparatus. FIG. 20 is a block configuration diagram mainly showing an electric configuration in an internal configuration of the image pickup apparatus.

An image pickup apparatus 10 in the present embodiment is mainly configured by an image pickup lens 20, an apparatus main body 30, and the like as shown in FIG. 17 and the like. The image pickup lens 20 is removably disposed on a front surface of the apparatus main body 30. Therefore, a lens-side mount member 23 is provided in a rear end portion of the image pickup lens 20. In a substantially center portion of the front surface of the apparatus main body 30, a body-side mount member 31 (shown in only FIG. 17) including an engaged unit with which the lens-side mount member 23 (shown in only FIG. 17) engages is provide to correspond to the lens-side mount member 23. Note that, as a lens attaching and detaching mechanism configured by the lens-side mount member 23 and the body-side mount member 31, for example, well-known various mount mechanisms such as a screw type and a bayonet type are applied. The image pickup apparatus 10 in the present embodiment having such a configuration is illustrated as a so-called lens interchangeable type image pickup apparatus in which the image pickup lens 20 is configured to be removably attachable to the apparatus main body 30.

The image pickup lens 20 is mainly configured by a lens barrel 21, an image pickup optical system 22, and the like. As the image pickup optical system 22, the zoom optical system configuring the zoom lens in the present embodiment is applied.

The lens barrel 21 is a housing member that houses the image pickup optical system 22. Note that, on the inside of the lens barrel 21, besides the image pickup optical system 22, although not illustrated, for example, various mechanism units including a driving source and a lens driving circuit for moving a predetermined lens group of the image pickup optical system 22 in a direction along an optical axis O and executing, for example, a power varying operation (zooming), a focusing operation (focusing), and the like are provided.

The apparatus main body 30 includes, besides the body-side mount member 31 explained above, an image pickup device 32, a control unit 40, a back display device 33, which is a first display device, a finder display device 34, which is a second display device, a plurality of operation members 35, and the like.

The image pickup device 32 is a photoelectric conversion element that converts an optical image formed by the image pickup optical system 22 into an electric signal and outputs the electric signal as digital image data in a predetermined form. The digital image data generated by the image pickup device 32 is output to the control unit 40 in the apparatus main body 30 (explained in detail below). The image pickup device 32 is disposed on an image-forming plane of the image pickup optical system 22. In this case, the image pickup device 32 is disposed on the optical axis O of the image pickup lens 20 behind the image pickup lens 20. At this time, an image pickup surface of the image pickup device 32 is disposed in parallel to a surface orthogonal to the optical axis O.

As the image pickup device 32, for example, a CCD (charge coupled device) type image sensor or a CMOS (complementary metal oxide semiconductor) type image sensor is applied.

The control unit 40 receives and temporarily records the digital image data outputted from the image pickup device 32 and executes various kinds of image processing as appropriate and outputs the digital image data to a recording apparatus, a display apparatus, and the like. At the same time, the control unit 40 collectively controls the entire image pickup apparatus 10 (explained in detail below).

The back display device 33 and the finder display device 34 are component units that display an image based on acquired image data and display a setting menu or the like when various settings or the like of the image pickup apparatus 10 are performed. The back display device 33 is the first display device that is disposed in a form for exposing a display surface to the outside, for example, on a back side of the apparatus main body 30 and configured to enable a user to observe the display surface with naked eyes. The finder display device 34 is the second display device that is provided on an inside of the apparatus main body 30 and is used in a form in which the user looks into the display surface enlarged by a finder optical system (not illustrated). These two display devices (33 and 34) are switched and used as appropriate by the user of the image pickup apparatus 10 according to a use purpose, a use situation, a taste of the user, and the like.

Note that the image pickup apparatus 10 does not always need to include both of the back display device 33 and the finder display device 34 and only has to include at least one of the display devices. As the back display device 33 and the finder display device 34, for example, a liquid crystal display device or an organic electroluminescence (OLE) display device is applied.

The plurality of operation members 35 are disposed on an outer surface of the apparatus main body 30. The plurality of operation members 35 are operation members including, besides, for example, a shutter release button and a photographing mode selection dial, a switch member for generating various action commands for, for example, performing various settings and switching an operation mode and transmitting an intention of the user to the control unit 40. As the plurality of operation members 35, operation members in various forms such as a push button type, a slide lever type, a rotary lever type, a rotary dial type, a seesaw type in a form capable of selecting four or two contact points, and a joystick type can be applied. Note that the operation member 35 also includes a touch panel 35a disposed on the display surface of the back display device 33 and associated with display on the display surface of the back display device 33, and the like.

Subsequently, an electric internal configuration of the image pickup apparatus 10 is briefly explained below mainly with reference to FIG. 20. The apparatus main body 30 of the image pickup apparatus 10 includes, besides the image pickup device 32, the back display device 33 (the first display device), the finder display device 34 (the second display device), the plurality of operation members 35 including the touch panel 35a, the control unit 40, and the like explained above, for example, an internal recording unit 36, a recording device 37, and a communication device 38 as shown in FIG. 20.

The internal recording unit 36 is a component unit fixed on an electric substrate or the like on the inside of the apparatus main body 30 and including an internal memory 36a, a driving circuit for the internal memory 36a, and the like. As the internal memory 36a, for example, a nonvolatile memory is applied.

The recording device 37 is a component unit fixed on the inside of the apparatus main body 30 and including a card slot mechanism unit that removably stores a recording medium 37a, a driving circuit that drives the recording medium 37a attached to the card slot mechanism unit, and the like. As the recording medium 37a, for example, a card memory including a nonvolatile memory or the like on an inside of a housing formed in a thin card shape or the like is applied. The recording medium 37a is provided removably attachable to the apparatus main body 30.

In the internal memory 36a and the recording medium 37a, besides image data acquired using the image pickup device 32 and various information incidental to the image data, a data file including various setting information and the like in the image pickup apparatus 10 can be recorded. Note that the internal memory 36a and the recording medium 37a can be switched and used as appropriate.

The communication device 38 is a component unit that performs transmission and reception of various information data using radio or wire between the image pickup apparatus 10 and not-shown external equipment (for example, an external image display apparatus, an external recording apparatus, and an information processing apparatus).

The control unit 40 is a processor that collectively controls the entire image pickup apparatus 10 as explained above, At the same time, the control unit 40 performs various kinds of data processing concerning the image data acquired by the image pickup device 32 and realizes various functions. Therefore, the control unit 40 includes, for example, an image pickup control unit 41, a temporary memory 42, an image processing unit 43, a display control unit 44, a recording control unit 45, an operation determining unit 46, and an information storing unit (a ROM) 47.

The image pickup control unit 41 includes a driving circuit that controls to drive the image pickup device 32 and the image pickup lens 20, and the like. The temporary memory 42 includes a memory circuit that temporarily stores the image data acquired by the image pickup device 32 and is used as a temporary work region at the time when various kinds of image signal processing explained below are performed, and the like.

The image processing unit 43 includes a processing circuit that applies various kinds of predetermined image signal processing and the like to the image data acquired by the image pickup device 32 and temporarily stored in the temporary memory 42, and the like. The image processing unit 43 may be configured by an electric circuit or may be configured by hardware specialized for a predetermined function (for example, image processing).

The display control unit 44 includes a driving circuit that controls to drive the back display device 33 and the finder display device 34, and the like. The recording control unit 45 includes a driving circuit that controls to drive the internal recording unit 36 and the recording device 37, and the like. The operation determining unit 46 includes a signal processing circuit that receives input signals from the plurality of operation members 35 including the touch panel 35a, performs determination about the received input signals, and transmits instruction signals or the like to component units or the like corresponding to the input signals as appropriate, and the like.

The information storing unit (the ROM) 47 includes a semiconductor memory that records, for example, software programs for realizing various functions concerning recording, display, setting, and the like, and various types of information prepared for the image pickup apparatus 10 in advance such as various setting menus, and the like.

As the control unit 40, a processor configured by a well-known component including a non-transitory recording medium (a non-transitory computer readable medium), peripheral equipment of the well-known component, and the like besides, for example, a central processing unit (hereinafter referred to as CPU), a ROM (read only memory), a RAM (random access memory), a nonvolatile memory, and a nonvolatile storage can be applied. In this case, the CPU reads out and executes the software programs for various functions recorded in the ROM or the like. Consequently, the processor realizes the various functions (recording, display, setting, and the like).

For example, the processor may realize the various functions with individual kinds of hardware or may realize the various functions with hardware obtained by integrating a part of respective functional units. For example, the processor includes hardware and the hardware includes at least one of a signal processing circuit that processes a digital signal or a signal processing circuit that processes an analog signal. As the processor, other than the CPU, various processors such as a DSP (digital signal processor) can be used. The processor may be configured by a hardware circuit by an ASIC (application specific integrated circuit), an FPGA (field programmable gate array), or the like.

The present invention is not limited to the embodiment and the respective examples explained above. It goes without saying that various modifications and applications can be implemented within a range not departing from the gist of the invention. Further, inventions in various stages are included in the embodiment and the respective examples explained above. Various inventions can be extracted by appropriate combinations in a disclosed plurality of constituent elements. For example, when the problems to be solve by the invention can be solved and the effects of the invention can be Obtained even if several constituent elements are deleted from all the constituent elements explained in the embodiment or the respective examples, a configuration from which the constituent elements are deleted can be extracted as an invention. Further the constituent elements explained in different embodiments or examples may be combined as appropriate. The present invention is not limited by a specific implementation mode of the invention except that the invention is limited by the appended claims.

What is claimed is:

1. A zoom lens comprising;
in order from an object side,
a first lens group having a positive focal length;
a second lens group having a negative focal length;
a third lens group including an aperture stop and having a positive focal length;
a fourth lens group having a negative focal length; and
a rear side lens group, wherein
the first lens group includes a negative lens and a positive lens disposed in order from a most object side,
the first lens group and the third lens group are fixed in power varying from a wide angle end to a telephoto end, and the second lens group moves from the object side to an image side in the power varying, and
the zoom lens satisfies following conditional expressions (1) and (2):
2.1≤F1/Fw≤3.0 (1)
−1.2≤F3/F2≤−0.8 (2)
where,
F1 is a focal length of the first lens group,
Fw is a focal length at infinity of the wide angle end of the zoom lens,
F2 is a focal length of the second lens group, and
F3 is a focal length of the third lens group.

2. The zoom lens according to claim 1, wherein the fourth lens group moves at a focusing time and includes one or more positive lenses and one or more negative lenses.

3. The zoom lens according to claim 1, wherein, in the second lens group, a lens on the most object side is a positive lens.

4. The zoom lens according to claim 1, wherein the second lens group includes three bonded lenses bonded in order of a positive lens, a negative lens, and a positive lens from the object side.

5. The zoom lens according to claim 1, wherein
in the third lens group, a lens disposed on the most object side is a positive lens, and
the zoom lens satisfies a following conditional expression (3):
vdG3F≥45 (3)
where vdG3F is an Abbe number on a d line of the positive lens disposed on the most object side of the third lens group.

6. The zoom lens according to claim 1, wherein
in the third lens group, a lens disposed on a most image side is a positive lens, and
the zoom lens satisfies a following conditional expression (4):
vdG3R≥60 (4)
where, vdG3R is an Abbe number on a d line of the positive lens disposed on the most image side of the third lens group.

7. The zoom lens according to claim 1, wherein the zoom lens satisfies a following conditional expression (5):
−5≤(1−(β4W)²)×(βRW)²≤−3 (5)
where,
β4W is a lateral magnification at a wide angle end of the fourth lens group, and
βRW is a lateral magnification at a wide angle end of the rear side lens group.

8. The zoom lens according to claim 1, wherein the zoom lens satisfies a following conditional expression (6):
−2.0≤F4RW/FW≤−0.8 (6)
where,
F4RW is a combined focal length from the fourth lens group to a wide angle end of a lens group on the image side, and
FW is a focal length of the wide angle end of the zoom lens.

9. An image pickup apparatus comprising:
the zoom lens according to claim 1; and
an image pickup device configured to convert an optical image formed on an image pickup surface by the zoom lens into an electric signal.
